(19) United States
(12) Patent Application Publication
(10) Pub. No.: US 2002/0198629 A1
(43) Pub. Date: Dec. 26, 2002

(54) Computerized utility cost estimation method and system

(75) Inventor: David D. Ellis, Middletown, DE (US)

Correspondence Address: HALE & DORR LLP, THE WILLARD OFFICE BUILDING, 1455 PENNSYLVANIA AVE, NW, WASHINGTON, DC, 20004, US

(73) Assignee: Enerwise Global Technologies, Inc., Kennett Square, PA (US)

(21) Appl. No.: 10/127,715

(22) Filed: Apr. 23, 2002

Related U.S. Application Data
(60) Provisional application No. 60/286,619, filed on Apr. 27, 2001.

(51) Int. Cl. G05D 3/12

(52) U.S. Cl. 700/286; 700/291; 705/412

(57) ABSTRACT

The invention provides a method, system, and computer program device for cost estimation relating to utility usage and utility billing. Utility information concerning usage of utilities is collected, and a report is provided of actual and/or estimated usage and/or cost of utility resources. Information is stored relating to customers, one or more utilities relating to the customer, as well as a variety of rules that may be applied by the utilities for the customers, depending on various situations, in determining the utility information and the costs thereof. Measurement related information and/or estimate related information is collected, representative of the utility usage and the estimated usage by the customer(s). A user may selected one or more preferences representative of a variable, which are utilized in generating the utility information for the user. The report is based on utility information relating to the customer, the preference for the variable(s), and the measurement related or estimate related information for the customer. A report is displayed, representative of the utility information utilizing the preference for the variable(s).

### RELATED APPLICATIONS

This application claims priority to U.S. Provisional Application Ser. No. 60/286,619 filed Apr. 27, 2001, and incorporated herein by reference.

### BACKGROUND OF THE INVENTION

1. Field of the Invention

The present invention is directed to computer-related and/or assisted systems, methods and computer readable mediums for presenting utility billing or cost estimates. More specifically, it relates to such methods and systems for presenting the actual or forecast billing information and/or cost estimates according to a number of variables, such as utilities' rules, various billing cycles, cost estimation, cost forecast, load forecast, applicable regulatory rules and/or benchmarking.

2. Description of the Related Art

Utilities are typically billed to the customers in the following way. A utility service provider (or its agent) has installed a system or has provided some means for collecting meter information measured by the meter on the characteristics and usage of the utility at a particular location. Each customer site may have a utility billing meter or some other device out in the field to measure utility usage, and perhaps other utility characteristics. The utility company extracts at least some of the meter information relating to utility usage from those meter devices.

The meter information is retrieved remotely from most customer facilities. One familiar type of remote retrieval of information is accomplished by the billing meter at a customer's facility, which may include a modem dial up system utilizing a plain old telephone system (POTS) line. One such prior art system for remotely collecting meter information from subscriber or customer premises is illustrated in FIG. 1, and also described in “Powerline Communications,” David Clark, IEEE Internet Computing, pp. 10-11, January-February 1998, incorporated herein by reference. The meter information is collected from the premises on a periodic basis at the box 103 connected to the meter, and forwarded to a street cabinet near a substation 105. Utilizing a frame relay network 107, the meter information can then be collected by a remote system. FIG. 2 similarly shows a prior art system for remote collection of meter information illustrating use of a modem to transmit collected meter information and is described in U.S. Pat. No. 5,699,276, Roos, incorporated herein by reference. In this example, meter information is collected at the customer's house 201, via a standard meter 203. The collected meter information is periodically transmitted via a modem processor 205 to the utility company 207.

Meter information is typically extracted on a monthly basis, to coincide with the usual monthly billing cycle for the customers. A monthly billing statement is prepared, reflecting the underlying meter information, and mailed. The customer then may review the billing statement and the underlying meter information reported on its monthly billing statement, when received.

Nevertheless, some customers may benefit from the ability to collect and review the meter information more frequently. Some customers may wish to collect the meter information on an hourly basis, or a weekly basis. Alternatively, some customers may wish to have access to current, real time information. We have determined that the ability to review meter information at varying frequencies or on demand is desirable, but is unfortunately not provided by periodic billing statements. Of course, a billing statement cannot provide real time information.

Similarly, it is possible that customers may wish to have flexibility in the information presented in a billing statement. For example, the usual billing meter information concerning consumption may be less information than some customers would like. Further, we have determined that it is desirable that the utility billing meter collects utility characteristic information which is not included in a billing statement. Unfortunately, we have determined that the typical billing statement is insufficiently flexible to accommodate a wide variety of information, and is incapable of same.

Power utilities are of particular note in this connection. The following description details such power utilities. We have determined that similar concerns, however, apply to other utilities, such as telephone, water, sewer, and gas as well as any other metered utility.

The components of power utility usage include “real power”, “reactive power” and “apparent power”. We have determined that a billing statement does not generally reflect each of these components. Real power is commonly referred to in kilowatts; it is used by machinery to produce a product. In contrast, reactive power is typically used by certain pieces of machinery in order to merely make that machinery work. Reactive power is not regarded as a power that does real work; it is merely used to establish a field, such as a magnetic field in induction machines. Apparent power is the sum of real and reactive power. Apparent power is an alternative way of measuring power.

A conventional power meter will generally provide meter information reflecting the real power component on a consumptive basis and on a demand basis. “Consumptive basis” is an accumulation of the number of hours and the rate at which the power is used. “Demand basis” reflects the amount of power used in a finite period; from the demand basis one can determine the maximum demand for power. Utilities typically reference both a consumptive and demand basis for real power in determining rates and hence billings, since periods of high demand are billed at a greater rate. Some utilities utilize apparent power instead of real power in generating utility bills.

In addition to power component information, meter information may reflect other information as well. This additional meter information may include, depending on the meter device, time of use, peak demand, load, power outage information, voltage, current, and power factor. This additional information is not necessarily shown in a billing statement, even if a customer desires to review it.

For utility meters located outside a customer's facility, the utility will typically query the meter or poll the meter for information at a periodic interval corresponding to the billing interval, collect the meter information for the interval, and store the meter information in a customer information system. The communication with the meter can be accomplished in a number of ways, including network access, POTS, mobile access, and long range radio. Alternatively, meter readers may be utilized to manually collect and enter meter information. The collected meter information is then used to generate monthly billing statements.

The billing statement is typically in a standardized format with which the customer becomes familiar, and the statement presents standard information. In a typical utility bill format, a number of line item charges are usually included. These line items differ depending on the customer and the customer's location.

However, there are many factors and considerations that affect a customer's billing statement and the fees reflected therein. For example, the amount billed is not necessarily a straight line reflection of energy consumption. We have determined that many utilities charge different rates depending on the usage. As another example, various states have different tax rules, and any particular state may alter its tax rules. Similarly, city taxes may be required.

Moreover, we have determined that various bills might be calculated on different specific rates. For example, a customer may be subject to certain rates based on kilowatt hours used. Different rates may apply at different levels of usage of kilowatt hours. Even within the same utility, different customers may utilize different standard calculations. Hence, a billing statement is a reflection of what may be a complex set of calculations and considerations.

In addition to the above complexities affecting billing statements, some utilities provide financial incentives, such as an opportunity for financial revenue, based on participation in a curtailment program. Curtailment typically takes the form of the customer's agreement to participate in a program hosted by a utility. The curtailment program may be “voluntary” or “involuntary.” “Involuntary” curtailment involves the customer agreeing to reduce its load by a particular amount, for example, 10 megawatts, at the utility's convenience, in exchange for certain fee. “Voluntary” curtailment commences with an offer from the utility on a periodic basis to provide a fee for reduced power usage in a defined period of time; the customer may accept or decline the offer of fee for curtailment.

Certain aspects of conventional systems for utility resource management are illustrated by way of example in FIG. 3, also described in U.S. Pat. No. 6,088,688, Crooks et al, incorporated herein by reference. In this computerized system, a database is defined, block 300, in which customer meter information is stored, block 310. Meter information concerning resource usage is received from a resource provider, block 320, pertaining to consumption of a resource by a customer. The resource usage information is processed to provide computer-viewable data, block 330. According to one feature of this particular system, an audit process 340 includes a step of defining tolerance parameters 350. If the resource usage information at block 360 does not satisfy the tolerance parameters, the information may be flagged for remedial processing, such as error checking. The tolerance parameters may be defined through historical billing data for the customer. Although this system may collect and verify usage information, it does not assist in predicting fees or costs.

Accordingly, we have determined that the complexities affecting billing statements make it extremely difficult for a utility customer to predict how fees would change in various scenarios. We have determined that a customer might want to determine how its fees would change if it moved to a different city or state; or how its fees might change if it shifted the demand to a different time of day; or how participation in curtailment would impact its fees; or how even continuing current utility usage will impact its fees.

Unfortunately, conventional systems fail to expand the potential uses of the meter information that may be collected. Moreover, none of these conventional systems permit the customer to perform its own estimations, planning and bill review, according to the parameters which the customer defines as important. Thus, using conventional systems, it is not possible to forecast utility usage or estimate costs. There remains a need in electrical and other utility industries for such a system.

### BRIEF SUMMARY OF THE INVENTION

The present invention alleviates the deficiencies of conventional techniques and systems described above. It extracts meter information, deposits that information into a database, and presents that information, such as over the web, in a format that is useful for the end user. The meter information is remotely extracted from the customer's meter, by any appropriate and/or standard method. The meter information is stored, and then may be queried by the customer. It is highly advantageous that the meter information is provided on the basis needed by the customer, for example for periodic monthly bills, hourly data, real time data, etc. The information that the customer wants to access, even if not conventionally available, is presented. Moreover, the meter information is processed and presented in a way that permits manipulation of data by the users themselves. The customers may utilize this to show usage, and/or to forecast predicted usage and/or cost estimation. Moreover, the meter information may be processed and presented in a format that is customer-friendly, and that the customer is accustomed to seeing, such as similar to a typical bill format.

The invention provides a method, system, and computer program device for managing utility information responsive to at least one of usage and estimated usage of utility resources. Information is stored regarding at least one user, at least one utility relating to the at least one user, and a plurality of rules that may be applied by the at least one utility for the at least one user in determining the utility information. Measurement related or estimate related information is collected, representative of the at least one of the utility usage and the estimated usage by the at least one user. At least one preference representative of a variable is selected and utilized in generating the utility information for the at least one user. The utility information for the at least one user is generated, responsive to the at least one preference, the utility information relating to the at least one user, the at least one preference, and the measurement related or estimate related information for the at least one user. A report is displayed, representative of the utility information utilizing the at least one preference.

According to one or more embodiments, the measurement related or estimate related information is acquired remotely from at least one of: a utility meter, a database of meter information, a periodic reading of a utility meter, and a demand reading of a utility meter.

According to one or more embodiments, the utility resource is power characterized by power component information, and the power component information includes real power, apparent power, and reactive power; and the measurement related or estimate related information comprises at least two of the real power, the apparent power and the reactive power; and wherein the generated utility information including calculated billing information comprising one another of the at least two of the real power, the apparent and the reactive power.

According to one or more embodiments, the utility resource is power, and the variables include at least one of time period, site, tariff, state tax, city tax, billing cycle, energy usage, location, and curtailment.

According to one or more embodiments, the user comprises at least one of an energy provider and a customer with multiple facilities.

According to one or more embodiments, the report includes actual usage, forecast usage and/or cost estimates, responsive to data input by the user; and the preference reflects at least one of: location, demand, time shift, curtailment participation, extrapolation of current usage, adjustment of current usage, billing period and tariff.

According to one or more embodiments, an estimated forecast of a utility billing statement for the user, is provided responsive to the at least one preference.

According to one or more embodiments, the report comprises a plurality of sites, and the report includes a summary corresponding to the plurality of sites.

According to one or more embodiments, the report includes at least one line item selected from: delivery charge, service charge, transmission charge, customer charge, distribution charge, computer transmission charge, environmental fund rate, low income fund rate, and power factor adjustment.

According to one or more embodiments, the report has a format resembling a printed billing statement.

According to one or more embodiments, there are further provided components selected from: estimating cost, reporting exceptions, forecasting cost, benchmarking, providing market prices, and analyzing report information; and the component(s) utilizes at least one of: the measurement related information, the estimate related information, and the user information.

According to one or more embodiments, an effect on cost of participation in a curtailment program is determined, responsive to a request of the user. Optionally, further, if the user selected participation in the curtailment program, the user's curtailment is verified.

According to one or more embodiments, at least one of the measurement related information, the estimate related information, and the user information is stored in at least one table.

According to one or more embodiments, the information stored in the at least one table includes at least one of: peak periods, holidays, bill rates, tariff information, factor information for line items, and billing factor criteria..

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING(S)

The above-mentioned and other advantages and features of the present invention will be better understood from the following detailed description of the invention with reference to the accompanying drawings, in which:

FIG. 1 is an illustration of a prior art system for remote collection and distribution of meter information;

FIG. 2 is a block diagram of a prior art system for remote collection and distribution of meter information from a customer's site to utility company;

FIG. 3 is a flow chart illustrating one example of a prior art system for storing and processing customer utility meter information and providing computer-viewable data;

FIG. 4 is a data flow diagram illustrating one example of a data depository for web presentation, including a billing engine, according to the present invention;

FIG. 5 is a block diagram illustrating one example of an architecture of the billing engine;

FIGS. 6A through 6C are exemplary user interfaces illustrating cost estimation via the billing engine;

FIG. 7A through 7B are exemplary user interfaces illustrating a report of cost estimate results from the billing engine;

FIG. 8 is an example diagram illustrating cost estimation in connection with the billing engine, and data flow therefrom;

FIG. 9 is an example process flow diagram showing one possible process flow for the billing engine of FIG. 4;

FIG. 10 is a block diagram illustrating the billing engine of the present invention used in connection with a networked architecture including the Internet;

FIG. 11 is a block diagram an example network architecture in which the billing engine of the present invention is implemented;

FIG. 12 is an exemplary user interface illustrating a line graph display;

FIG. 13 is an exemplary user interface illustrating a bar graph display; and

FIG. 14 is an exemplary user interface illustrating a line graph display for a curtailment report option.

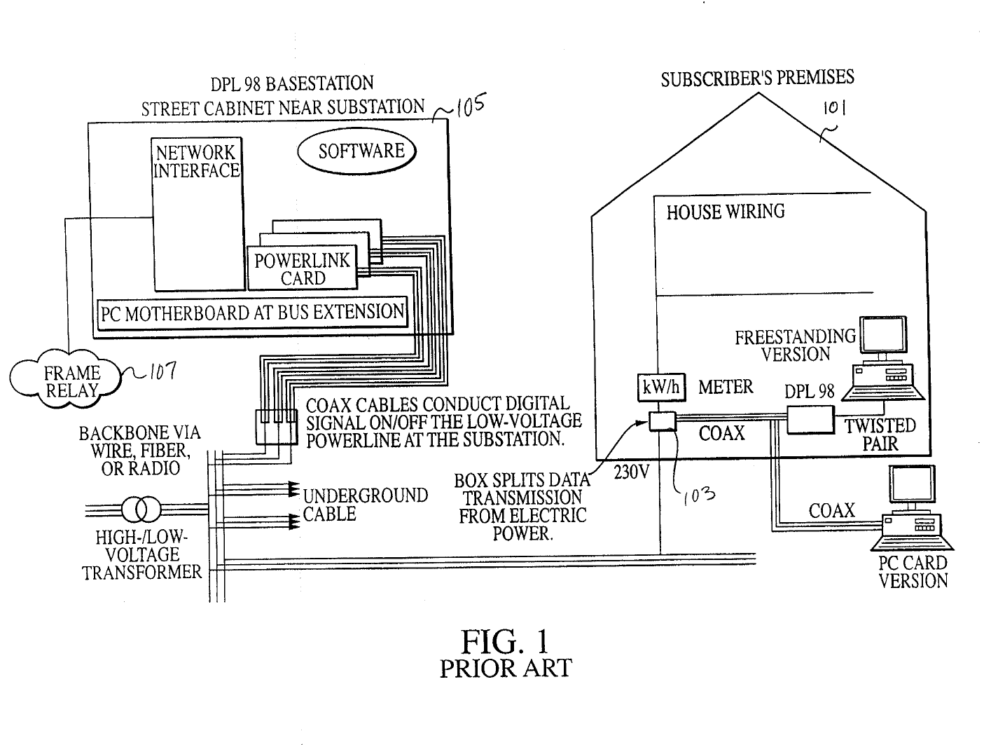

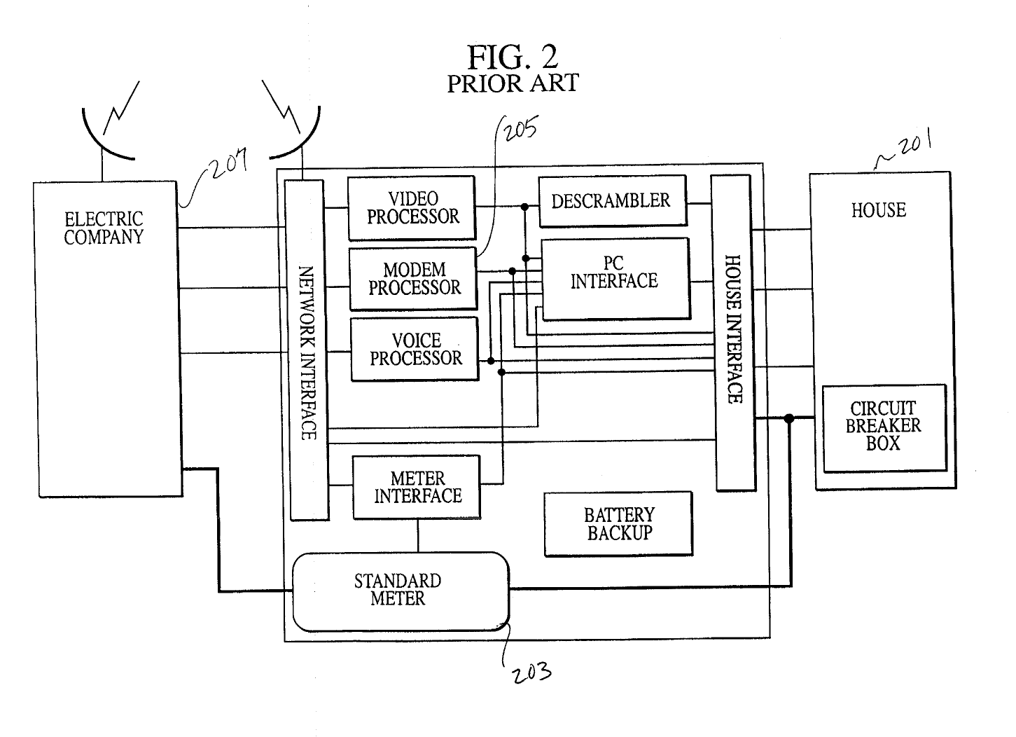

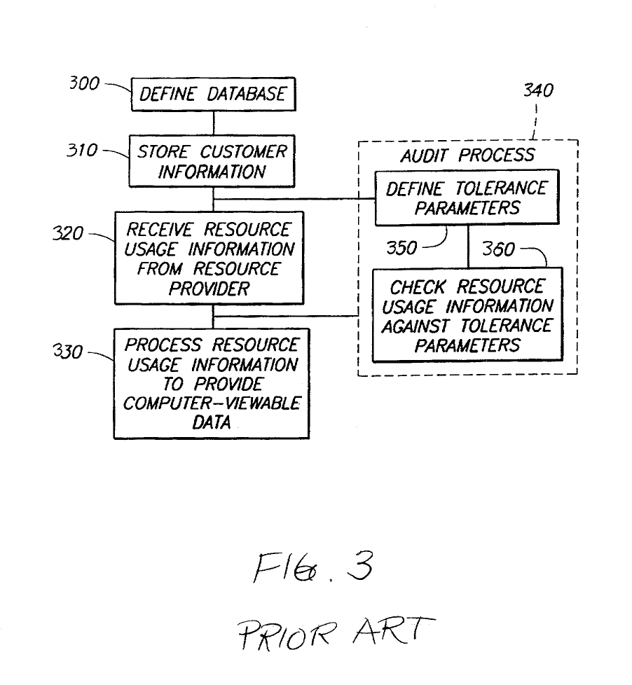

### DETAILED DESCRIPTION OF THE INVENTION

The following detailed description includes many specific details. The inclusion of such details is for the purpose of illustration only and should not be understood to limit the invention. Throughout this discussion, similar elements are referred to by similar numbers in the various figures for ease of reference. In addition, features in one embodiment may be combined with features in other embodiments of the invention.

In accordance with the invention, meter information regarding utility usage by a customer or other source that has been extracted from utility collection and/or billing meters is deposited into a database, and ultimately presented to an end user on behalf of a customer, such as on a web site over the World Wide Web, i.e., the Internet. The user may use the meter information to prepare various reports of utility billing information relating to actual and/or forecast utility usage and/or cost estimations for the customer. The reports may encompass any of the various variables such as user-defined billing periods, and may optionally include information not reflected in the standard billing statement. Advantageously, the present invention optionally allows the user on behalf of the customer to estimate their own energy usage responsive to estimated usage parameters, and further provides the customer the ability to define their usage requirements responsive to altering their usage parameters via the cost estimation of the present invention as described below is detail.

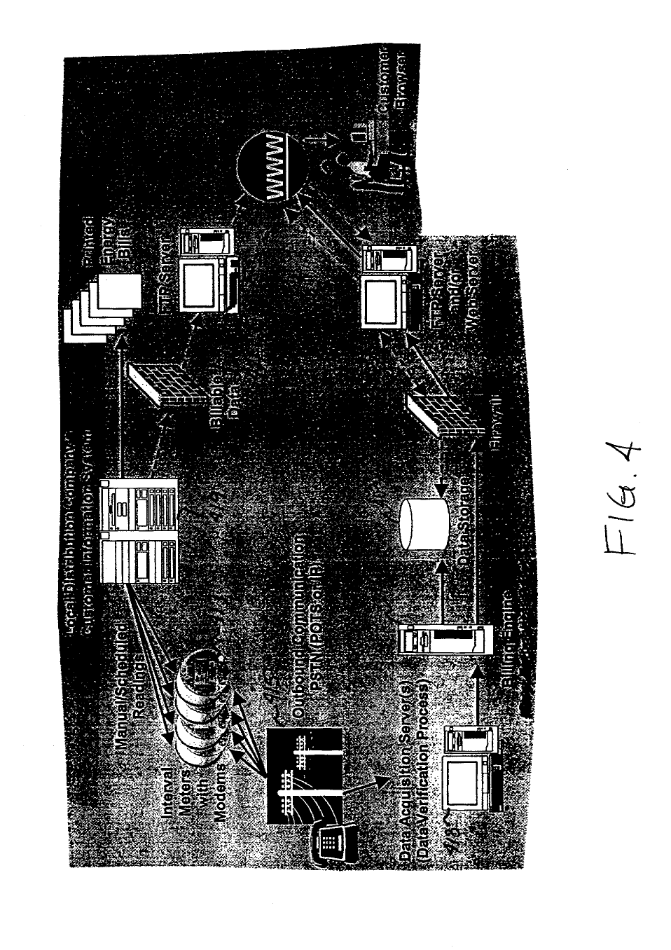

FIG. 4 provides an overview of an example network, encompassing utility billing meter collections, in connection with which the invention may be used. Although a number of elements are depicted in connection with the network, not all of the elements are required in order to operate the invention. As illustrated in FIG. 4, such a system may include a billing engine 401, data storage 403, and optionally, a firewall 405. The billing engine 401 stores and retrieves meter information into the data storage 403, and transfers meter information in at least some embodiments through the firewall 405. Similarly, meter information is received and stored in at least some embodiments via the firewall 405 into the data storage 403. Such a network also includes means for communicating over a network, such as an FTP server and/or web server 407, communicating with a World Wide Web 409 or other communications network. In the illustrated example, the billing engine 401 communicates with the World Wide Web 409 through the firewall 405 via the FTP server 407. A customer browser 411 or other user interface may be connected to the World Wide Web 409, or other appropriate communications medium, for communication of user queries and responses to and from the billing engine 401. Optionally, the system may utilize any conventional communication system.

The billing engine 401 also receives meter information from a data acquisition server 413 or data verification process. The data acquisition server 413 receives meter information representative of utility readings from utility billing meters via communication lines 415. The data acquisition server 413 uses the communication lines 415 to send commands, transmit requests and receive information to/from utility billing meters, such as the illustrated interval meters with modems 417.

The interval meters with modems 417, or other utility billing meters, receive and respond to manual and/or scheduled reading requests from a local distribution company's customer information system 419 by transmitting meter information for the interval(s). The meter information is stored locally at the customer information system 419. The customer information system 419 may utilize locally stored meter information in order to generate printed energy billing statements 425 for various customers of a utility. The meter information from the customer information system 419 is also communicated to the billing engine 401, optionally through a firewall 421, to the World Wide Web 409, via an FTP server 423, or via other appropriate communications methods. The system may optionally receive meter information through other standard processes and/or systems.

As will be appreciated, there are several ways in which utility billing information, reflecting meter information, may be reviewed. One limited manner of reviewing utility billing information is via a standard printed energy billing statement 425. Another manner in which a customer may review utility billing information is by electronically reviewing the billing statement. According to the invention, a customer may adjust variables affecting the billing statement and receive a report of utility billing information reflecting the adjusted variables. Also, some customers may prefer to receive more current and/or real time information. There are also a number of ways in which information concerning metered usage may be retrieved, either directly or indirectly, from utility billing meters. According to at least some embodiments, the meter information may be acquired by periodic polling, acquired on-demand, collected from the utility billing meter, and/or from some system that collects meter information (such as the customer information system 419).

Some systems may retrieve meter information from an existing utility billing meter 417 or other standard metering device. It may be desirable to have in place a device for remotely extracting meter information from the billing meter. Such a device could be, for example, a modem dial-up system and standard POTS lines 415. Other remote communication devices and methods are possible, as well. By utilizing remote access, the billing engine 401 can access an existing or conventional utility billing meter that is ordinarily utilized for monthly billing by the utility. The billing engine 401 can extract meter information, such as interval data, as defined by the billing engine. Responsive to a user request, the billing engine may determine to collect real time meter information, or to extract some or all of the full range of utility usage information. Typically, a request to the utility billing meter for its current reading simply results in a response with the current reading. The retrieved meter information is then stored for further use in connection with the billing engine 401 in the data storage 403. The billing engine 401 and data storage 403 may run on the same server, or may be distributed and run on one or more separate servers.

The stored meter information may then be referenced in connection with a query by the customer browser 411 or from an appropriate application server. The functions of the billing engine may optionally be distributed among separate servers, programmed devices and/or computer systems.

Meter information may be obtained on an as-needed basis from, for example, a standard remotely accessible utility billing meter. Therefore, remote access of a utility billing meter is particularly useful for customers who desire information more frequently than available in connection with the standard monthly billing statement. Remote access of a utility billing meter thus would be desirable for customers who prefer information at more frequent intervals such as hourly, quarter hourly, real time, or weekly.

Information that is not typically reflected in a billing statement, such as unprocessed and/or expanded meter power component information, may advantageously also be obtained from a utility billing meter in the present invention. Remote access, therefore, may be useful for customers who desire information beyond the conventionally available information on a billing statement. The typical information from a utility billing meter is limited to consumption and demand information, and perhaps some reactive power consumption information. Although some utilities generate utility billing statements based on apparent power, most utilities generate utility billing statements reflecting measured real power. By capturing at least two of the three power components in accordance with the present invention, however, all of the power components may be calculated. According to at least one embodiment of this invention, meter power component information, and/or other utility and usage information available from a utility billing meter, may be collected, manipulated and displayed as part of the reports of utility billing information, via the billing engine 401.

In FIG. 4, steps 417 through 423 illustrate a process which the utility, other customer and/or other third party utilizes for accessing and retrieving meter information from utility billing meters that reside outside of a customer's facility. The local distribution company's customer information system 419 optionally queries or polls the utility billing meters, typically on a periodic basis once a month, for meter information. The meter information is retrieved and stored, typically in the company's customer information system 419. The configuration of the customer information system varies from customer to customer, and may be a distributed system or a single computer system, and may be of any size/capacity. The collected meter information is used by the customer information system to print energy bills 425. The energy bills utilize the meter information that was retrieved from the utility billing meters. The meter information may be obtained by personnel utilizing handheld devices or transcribing the physical reading from the meter. The meter information thus manually entered is stored in the customer information system. It would be preferable to utilize an electronic meter with a modem, in order that the meter information may readily be retrieved remotely, without requiring manual intervention.

The meter information from the local distribution company's customer information system is transmitted to the billing engine 401. In the illustrated method, the meter information is transmitted to the World Wide Web 409, via a firewall 421 and an FTP server 423. The billing engine then receives the meter information from the World Wide Web 409 via its own FTP server or web server 407, through the firewall 405, and then stores the received meter information in the data storage 403. The meter information may be transmitted from the customer information system 419 to the billing engine 401 in any of several standard ways, including for example standard polling techniques or a specific request from the billing engine. Other standard communication protocols could be utilized in order to retrieve the meter information. For example, the customer information system 419 could initiate a transfer of the meter information to the billing engine 401 at the time that the customer information system has new meter information.

Hence, meter information coming into the billing engine 401 may be received coincident with the monthly billing cycle, or at a more or less frequent interval. The meter information can be processed in the same processing path, regardless of the interval frequency or the retrieval technique.

The illustrated system shows a file transfer protocol (“FTP”) server 423 used to transfer data representing the meter information which is stored in a file. Some utilities might prefer to utilize FTP for communication of data. Alternatively, the data representing the meter information may be transferred using any appropriate communication protocol. As another alternative, the customer information system 419 stores the meter information in a remote database such as on a hard drive of a personal computer (PC) a mainframe, or other standard database, to be retrieved by the billing engine. Ultimately, the meter information which is received or retrieved is utilized by the billing engine.

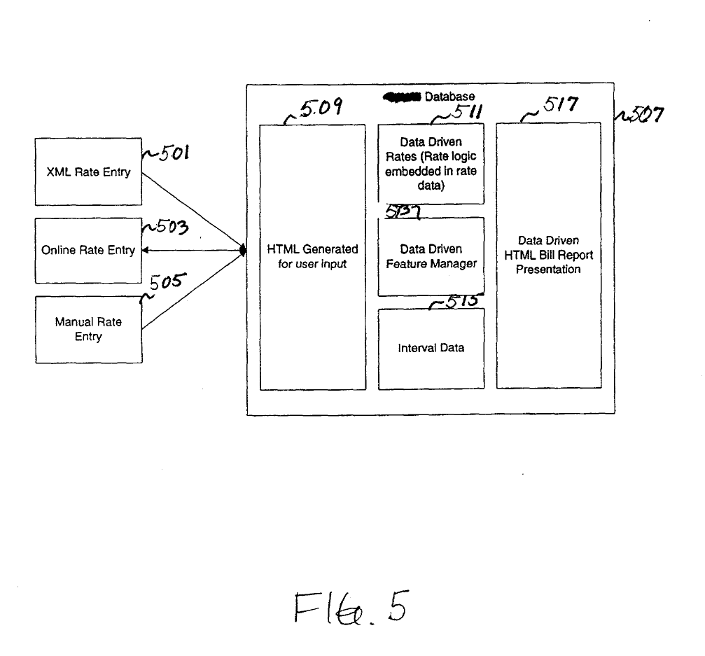

Reference is now made to FIG. 5, illustrating one potential architecture for the billing engine shown in FIG. 4. The billing engine includes various ways to enter information and/or variables affecting or relating to utility billing statements and/or used in preparing reports of actuals, forecasts and cost estimates for utility billing information. In the illustrated example, the information entry concerns meter rates 501, 503, 505. The billing engine also includes a database and report generators 507 for storing, processing, and presenting meter information, utility billing information, and variables.

Rates are entered via an appropriate standard user interface, such as via XML 501, via online rate entry 503, and/or via manual rate entry 505. The rates are indicative of calculations which ultimately result in the fees shown in a utility billing statement. Rates are discussed by way of example herein.

The database and report generators 507 include some means for generating user interfaces, inputting information specified by a user, making appropriate calculations and presenting utility billing reports. In this particular example, the billing engine generates user interfaces via a typical method for generating hypertext markup language (HTML) pages 509. However, any other appropriate method may be used to generate user interfaces and input user responses.

Also illustrated in FIG. 5 are data driven rates storage 511, for rates which in at least some embodiments have the rate logic embedded in the rate data. Such rates may include related procedures or methods for determining the rate, riders and/or other components that impact a utility billing statement or report of other actual or forecast billing information and cost estimates. Various fees in utility billing statements are based on specific rates. The data driven rates storage 511 accumulates utilities' rules for determining rates. Advantageously, the various rules utilized for calculating rates are stored in a rules library, and may be accessed for use in making calculations.

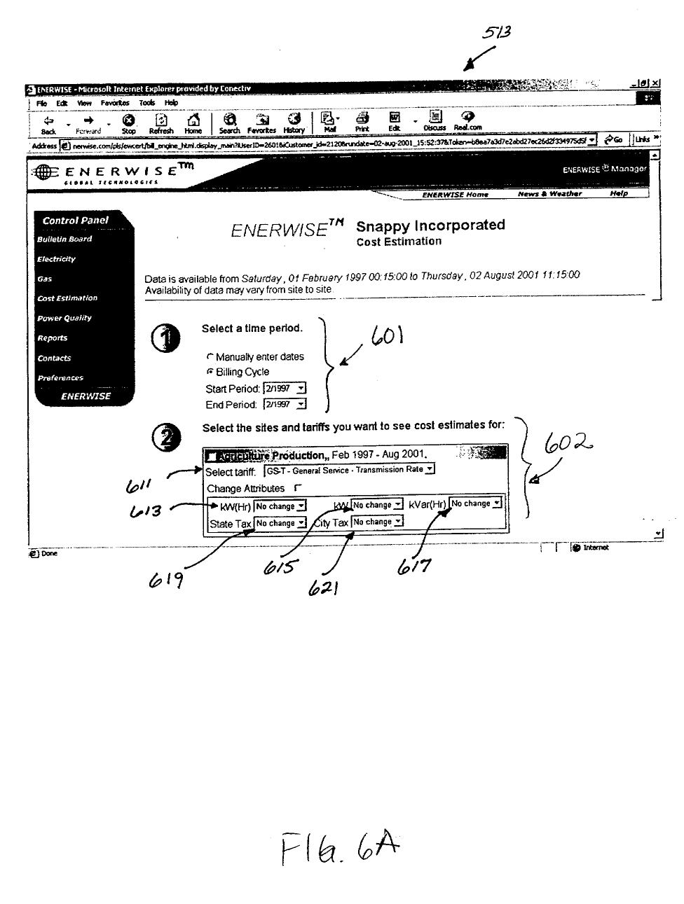

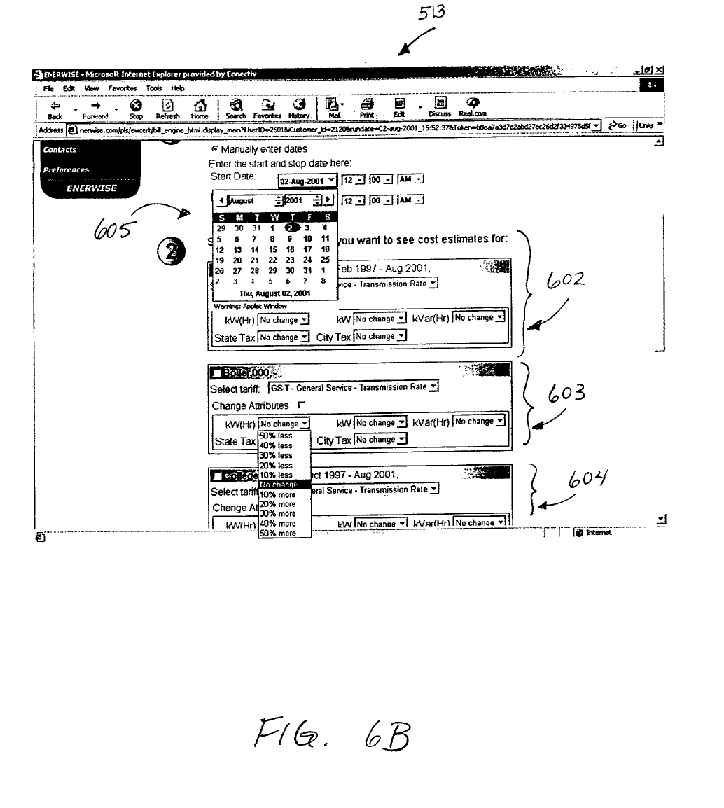

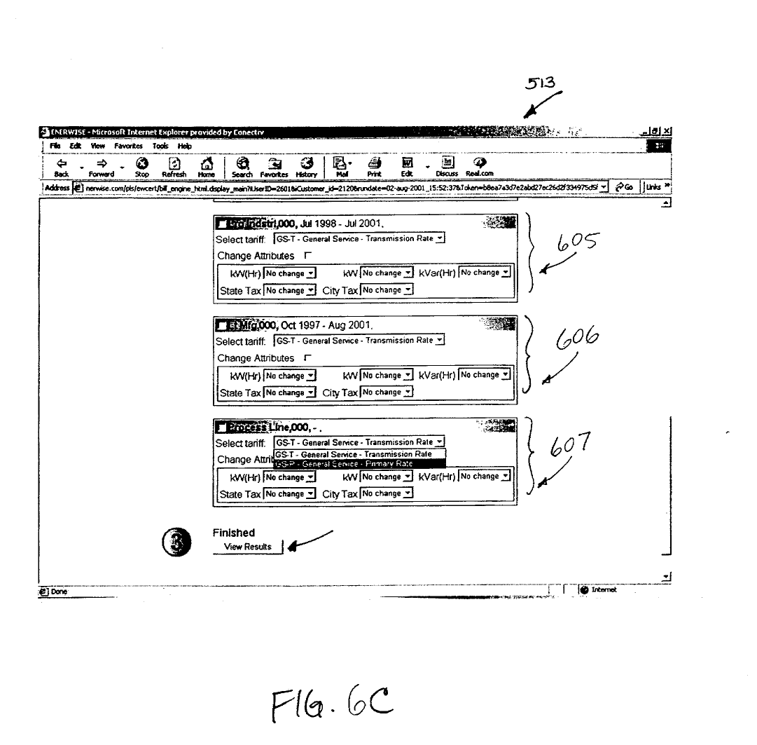

The billing engine optionally includes a feature manager 513. The feature manager 513 allows the billing engine to determine which variables may be adjusted. FIGS. 6A-C, described below, illustrate an example feature manager for the present billing engine which allows a change to certain attributes. The feature manager 513 provides the user with the ability to change variables that are utilized in preparing utility billing statements, and in preparing reports of actual usage, forecast usage, and cost estimates. According to at least some embodiments, the feature manager has embedded logic for standard calculations relating to variables described below.

Interval data storage 515 is provided for retaining meter data, including interval data, utility usage data, utility demand data and any other data retrieved as part of the meter information from the utility billing meters. Power utility data typically is expressed as kilowatt hours and normally is associated with a measure of usage. Demand data typically is defined in smaller intervals, and defines the maximum amount of energy used in some pre-defined interval. Various utilities utilize different periods, including for example 15 minutes or 30 minutes, as the pre-defined interval for which interval data is collected. Demand data is able to measure periods of time when there is an increase in energy usage. Usage data reflects an overall accumulated usage.

The billing engine also includes a section for providing a data driven HTML bill report presentation, block 517. The bill report presentation 517 provides for the presentation of bills. The reports are data driven, that is, the information and/or variables affecting or relating to utility billing statements and/or used in preparing reports of actual usage, forecast usage and cost estimates, as modified by the user, are automatically plugged into or displayed via an HTML report which automatically generates a report in accordance with the user-provided information, collected meter information, and rate information.

Reference is now made to FIGS. 6A-C, illustrating an exemplary user interface for reports of actual usage, forecast usage and cost estimates for utility billing information from the billing engine. The user interface permits the user to alter variables, and thus to display actual usage, forecast usage and/or estimates of cost. According to at least some embodiments, as in this example, the variables which may be altered include time (billing) period 601, and site tariff 602-607. For each site/tariff 602, in at least some embodiments, a user may adjust the type of tariff 611, kW(Hr) 613, kW 615, kVar(Hr) 617, state tax 619, and city tax 621. Any combination of variables affecting the utility billing information may be used. Indeed, in other embodiments, other standard variables may be provided in addition to, or in place of, the variables in this example. Such standard variables might include, for example, best and worst case scenarios based on this year's pricing and/or cost estimate fluctuation and/or previous years' historical pricing and/or cost estimate fluctuation.

In the example shown in FIG. 6B, the user is altering the time period 601 to be utilized for the estimation period. Here, the billing engine is defaulting to the standard billing cycle of February 1997. Alternate billing cycles or specific dates may be selected or specified, if preferred. The user interface will take into consideration that the billing cycle varies depending on the utility by referring to the rules for billing cycles for that utility. For example, the “August” billing cycle may encompass July 25 through August 15.

The user may select particular sites and/or tariffs 602 to be included in reports of actual usage, forecast usage, and/or cost estimates. In this example, the sites for this particular customer include Agriculture Production 602, Boiler 603, College 604, Lrg Indstrl 605, Lt. Mfg 606, and Process Line 607, illustrated in FIGS. 6B-C.

Variables affecting the fees may be adjusted by the user: various applicable tariffs may be selected and applied to a particular site, the state or city taxes may be altered. The energy usage may be altered as well. Any or all of these and/or other variable attributes affecting reports of actual usage, forecast usage and/or cost estimates may be displayed and altered, if preferred, by the user. In the illustrated example, these variables are specified and applied within a particular site. However, it may be desirable to provide that a user may apply one or more variables globally to a set of sites for a customer.

By utilizing the user interface and the ability to adjust variables, the user may provide an estimated forecast of its utility billing statement in specific scenarios. For example, a scenario might include a reduction of consumption by 40%. The cost estimate report displays results derived from a calculation of how such a reduction would impact the utility billing statement. In another example, a forecast estimate report is made by adjusting state tax to reflect a 20% increase. The results of the cost estimate report display show how that adjustment will impact the customer's billing statement.

In the example illustrated in FIG. 6A, one of the rates that may be adjusted by selecting the tariff 611 includes general service transmission (GST) rate. A customer who has a GST rate is subject to certain rates per kilowatt hours used. A particular rate is applied to the first amount of kilowatt hours. Customers who have a GST rate will have an alternate rate which applies when the first minimum amount is exceeded. Other standard rules are utilized in determining rates. These rules may be specific to a particular utility. Even within each utility, these rules may be changed based on a customer's contractual rights. Based on the location of the customer and the utility utilized by the customer, the system selects and applies the correct standard calculation from amongst the stored rules in providing the report of actual usage, forecast usage and/or cost estimates.

Reference is now made to FIG. 6B. Here, for one of the sites, the user is specifying a billing cycle 605 which is non-standard. In this example, the user does so by entering start date and end date 605 to determine or specify the period of interest.

Consider, in this particular example, that the customer has five facilities under its care, including the three illustrated 602, 603, 604. The user selects the particular facility, for example by clicking on the tab associated with the facility. The user may select and change particular attributes, such as to select a different rate. As illustrated in connection with the Process Line Facility 607, in this example, the two possible rates for this facility are the GST and the General Service Primary (GSP) rates.

Once the user has altered the variables as desired, the user should in some way indicate that the alterations are complete, such as by indicating “finished” 609. Upon an indication that the variables have been adjusted, the billing engine makes the indicated calculations utilizing the adjusted variables, meter information, and stored rules.

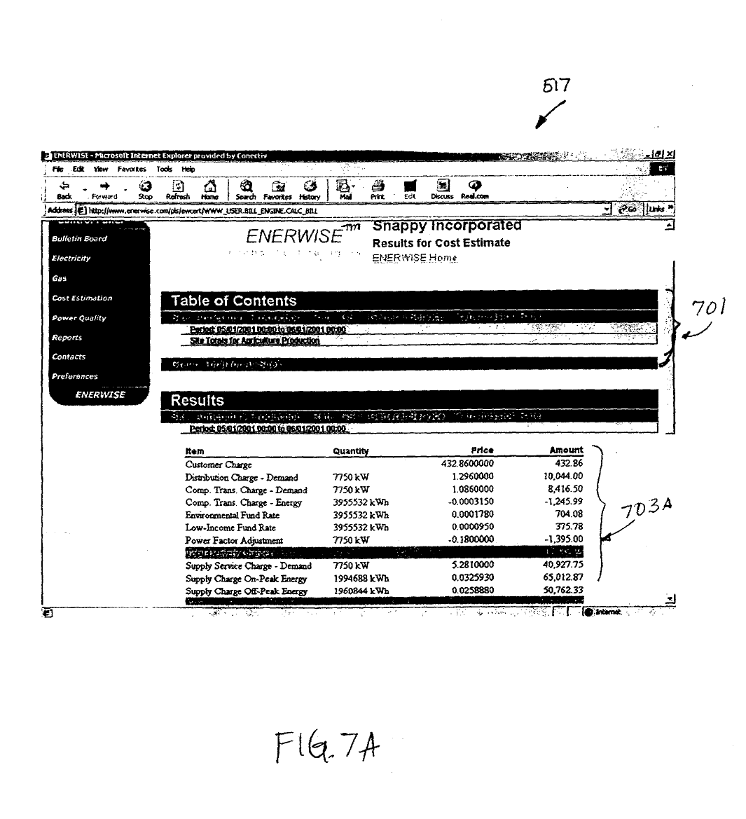

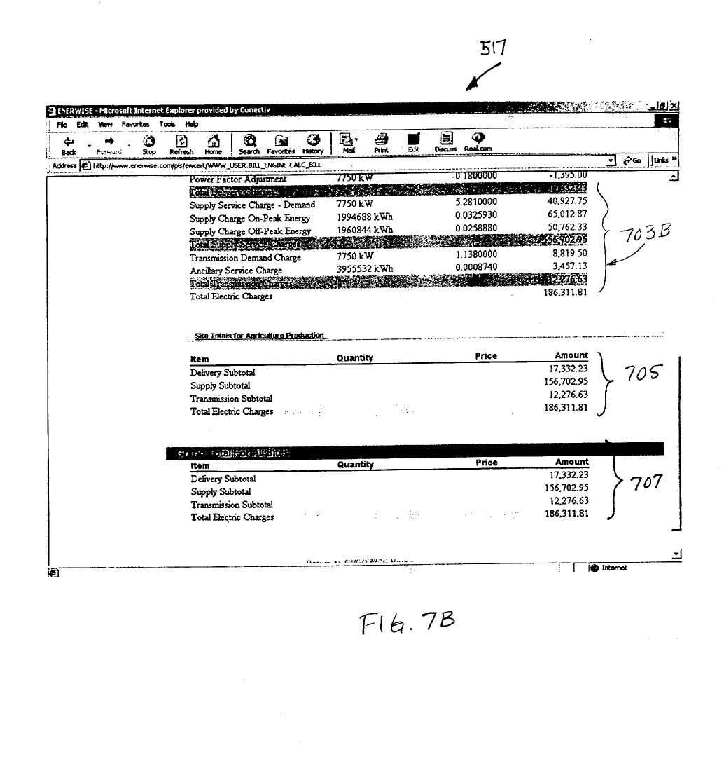

The system then produces a utility information report incorporating the altered variables, as illustrated in FIGS. 7A through 7B. FIGS. 7A-B display one exemplary format for the utility information report providing calculated results. Typically, the utility information report will include results for a customer covering multiple sites and thus the report may be spread over multiple pages. It is therefore advantageous for the report to include a summary such as an optional table of contents 701 or index.

Where the utility information report covers multiple sites or facilities, it is preferable for the report to be represented independently for each site or facility. A user may page through the utility information report by selecting a particular facility and any subcategory within that facility. In the illustrated example, the utility information report for each facility is further divided into subcategories by time period. Optionally, the present invention also contemplates a consolidated report for multiple sites and/or facilities.

In accordance with well known procedures for HTML displays, selecting a site from the table of contents automatically displays the details of the utility information report for that selected site. In the illustrated example, the selected site is “Agriculture Production.” The billing engine displays the utility information report for the selected site 703A through 703B, as well as the site totals 705.

The utility information report for each selected site and/or combination thereof optionally includes line items. Advantageously, line items which are detailed in the utility information report are those normally included in the printed utility billing statement for that customer. The utility information report preferably resembles a printed utility billing statement, in order to be familiar to a customer and therefore user friendly. In this example, the line items in the report for the Agriculture Production site 703A-B are subdivided into “Delivery Charges,” “Supply Service Charges” and “Transmission Charges”. The Delivery Charges include, for example, a customer charge, a distribution charge based on a demand rate, a computer transmission based on a demand rate, a computer transmission charge based on an energy rate, an environmental fund rate, a low-income fund rate, and a power factor adjustment. The utility billing statement for this customer would typically group these changes as a “total delivery charge”, and thus the utility information report also optionally includes a display of subtotal delivery charges. In this example, line items which are subdivided into “Supply Service Charges” include, for example, a supply service charge for demand, a supply service charge for on-peak energy, and a supply charge for off-peak energy. In accordance with the usual billing statement format for this customer, the supply service charges are also totaled and the subtotal is displayed. The subdivision of line items for Transmission Charges includes, for example, a transmission demand charge and an ancillary service charge. This subdivision is also totaled, and the subtotal is displayed. In accordance with the typical format of the printed utility billing statement, optionally the total utility charges are then displayed in the utility information report.

Note that the utility information report optionally includes a display of the summary of the subtotals 705. In this case, the subtotals include the delivery charge subtotal, the supply charge subtotal, and the transmission charge subtotal.

Utilizing the utility information reports, a user may adjust particular information, do an analysis, and obtain an estimate of a forecast or actual billing statement for a particular time period. Also, by utilizing the utility information report, a customer can determine if it is currently over or under or on target for its budget for energy. The customer may also run different hypothetical scenarios, such as moving a facility to a different state, to determine whether it is more cost effective to have a facility in an area with a particular rate versus a different area with a different rate.

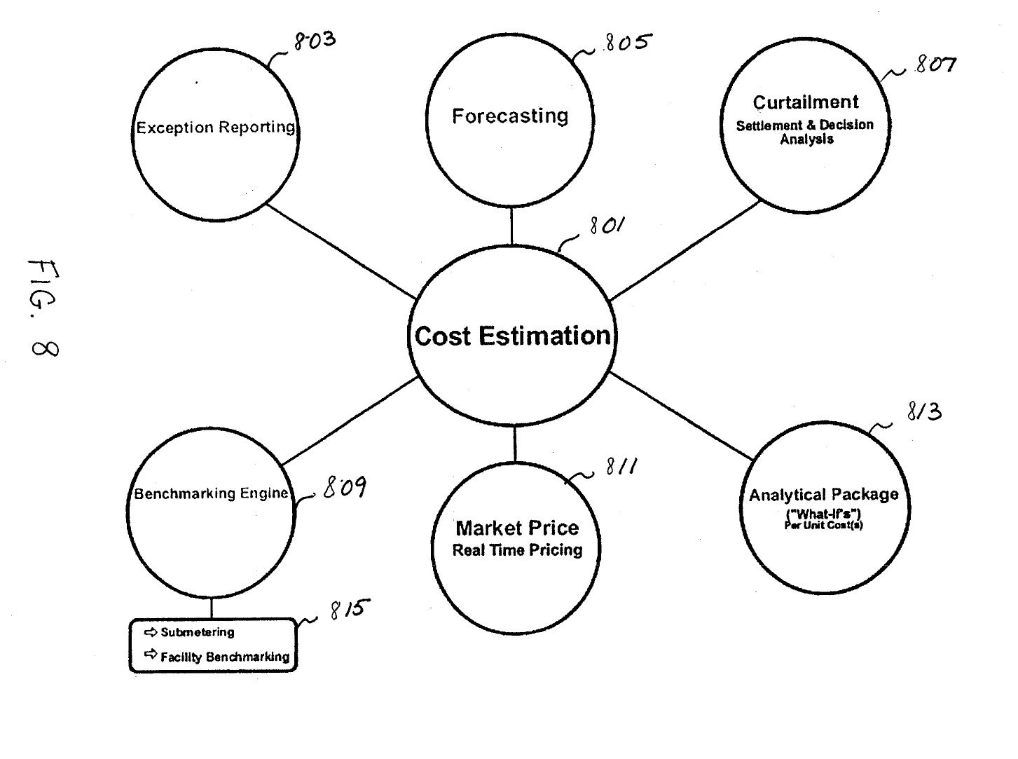

Reference is now made to FIG. 8, illustrating data flow relating to cost estimation utility information reports. This figure illustrates the data flow between various components relating to the billing engine, including cost estimation 801, exception reporting 803, forecasting 805, curtailment 807, benchmarking engine 809, market price 811, and an analytical package 813. One or more of these components may, if preferred, be used in connection with the cost estimation 801 feature of the billing engine, discussed above.

The exception reporting component 803 provides an exception report to the customer or user when the customer or user has exceeded some predetermined amount of energy utilization or demand. This could be based on, for example a rolling average over a period of time utilized as a baseline, or perhaps a forecasted number. The exception report could include information on energy utilization. It also could include information on costs. The exception report could also include information extrapolating the current meter information and advising the customer of the forecast estimated utility billing statement for a particular time period, if the current usage continues.

The forecasting component 805 may forecast load and may also optionally forecast cost associated with that load. This will allow a customer to anticipate and perhaps curtail load in order to maintain a particular budget.

Also illustrated is the curtailment component 807. This is another optional component. Curtailment includes the calculation of fees, based on a customer's anticipated reduction of a load. Certain utilities may provide an opportunity for financial revenue based on participation in a curtailment program. Curtailment can include voluntary or involuntary participation in a curtailment program. In order to decide whether or not to participate in an optional curtailment program, the customer may review cost estimation, in order to determine if it is feasible for the customer to reduce its utility usage. The customer can then determine if it will participate in a particular curtailment program, and what the effect would be for curtailing during a particular time period specified by the utility for curtailment. The curtailment system implemented by utility optionally includes a settlement process, during which the utility verifies that the customer did indeed curtail a load. The curtailment component 807 also provides for the utility to confirm that the curtailment occurred. Hence, the billing engine is optionally by the utility in order to confirm that the customer curtailed a load in accordance with its commitment, by comparing actual usage to any agreed-upon curtailment program. Optionally, the curtailment component 807 may be utilized to transmit a message to the customer announcing an invitation to participate in a curtailment event, and for the customer to respond to the invitation. Utilizing the cost estimation component 801, the customer itself may determine how much was saved based on the curtailment by comparing the usage applying the curtailment rates to usage without curtailment rates.

The system optionally includes a benchmarking component 809. The benchmarking component provides the ability to compare facilities to other facilities. For example, a customer may select a particular facility as its benchmark. Additional facilities of the customer can be compared against the benchmark. The comparison would generate a benchmark report. Preferably, such a report would reflect the differences from the benchmark facility. Any of the variables affecting utility billing information can be compared in the benchmark. Typically, one would prepare a benchmark report in connection with a comparison of utility usage.

Optionally, the system also includes a market price component 811. Many utilities tend to use a hybrid model to determine pricing, utilizing real time pricing rates together with location marginal prices, as an alternative to standard tariff rates. Some utilities use a combination of both market price and tariff rates. Accordingly, the market price component 811 obtains and integrates the information for those utilities that are utilizing market pricing, and incorporates that information into the cost estimation calculation 801. Utilization of the market price 811 is an alternative to applying the tariff rule that would ordinarily be applied by the cost estimation component 801. The market price component 811 provides the flexibility to utilize the tariff rate, or alternatively the market pricing rate, or a combination thereof. For example, a customer may use a fixed rate; once a particular load is exceeded, the customer may be billed at a locational marginal price. Thus, the customer would experience savings as long as its usage remains below some finite number for a load. Once the load is exceeded, the utility may bill the customer based on a market price. Thus, the market price component accommodates roof changes in utility billing statement.

The system optionally includes an analytical package component 813. The analytical package component was previously described in connection with FIGS. 6A-C and FIGS. 7A-B. The analytical package component provides the ability for a user to adjust variables, thereby providing “what-if” scenarios.

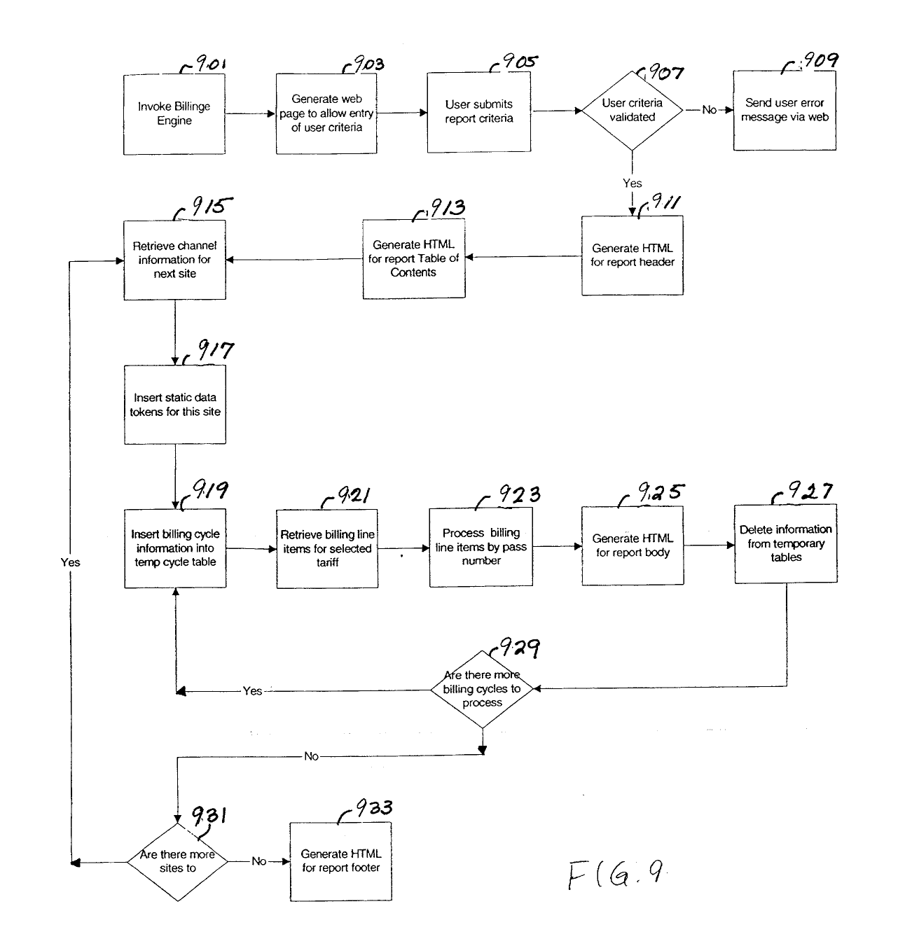

Reference is now made to FIG. 9, illustrating one example process flow diagram for the billing engine. At block 901, the user invokes the billing engine on behalf of the customer. This may be done by the user interacting with the user interface. Typically, once the billing engine is invoked, it would display a user interface, or other means for allowing entry of information and/or adjusting variables, block 903. The user may adjust variables at its discretion. At block 905, the user submits the entered information and variables to the billing engine. At block 907, the information and variables are validated, for example to ensure the selections are within proper ranges. If the information or variables do not pass validation, an error message may be displayed at block 909.

Once the user has input information and/or adjusted variables and it is validated, the system generates a utility information report. At block 911, the system generates an HTML for the report header based on the request. Referring to the example of FIG. 7, the header includes the phrase ENERWISE™ GLOBAL TECHNOLOGIES, and the customer name “Snappy Incorporated.” The header also indicates in this example that this is “the results for cost estimates”. The customer name is a dynamic portion of the header, optionally including the customer logo.

At block 913, the system generates an HTML for a report of the Table of Contents. It retrieves channel information for each of the sites that the customer has identified that it wishes to review. The Table of Contents lists each of these sites in order. This step, as well as the table of contents, may be omitted.

For each of the selected sites, the system prepares a utility information report. At block 915, the channel information for the next site is retrieved. At block 917, the system inserts static data tokens for the site. The data tokens are optionally used to indicate a particular set of rules based on particular rates utilized.

At block 919, the system inserts billing cycle information into a temporary cycle table. Billing cycle information would be based on the selected cycle range of dates. An internal table may be utilized in order to relate billing cycle information to particular dates.

At block 921, the system retrieves billing line items for the selected tariff. Billing line items include information such as customer charge and distribution charge. Examples of line items are specified in FIGS. 7A-B.

At block 923, the billing line items are processed, such as by pass number. The billing line items are retrieved, along with the customer charge. The customer charge would be a particular dollar amount based on utilization. The customer charge is calculated based on a particular rate applied to particular interval data from the customer's meter information in accordance with standard rate calculations. At this point, this billing engine calculates the line item charges based on the rules and the rates.

At block 925, the billing engine generates the utility information report, utilizing an appropriate display format, such as HTML. At block 927, the billing engine does housekeeping and cleans up in preparation for calculation of the next item. In this example, it deletes data from temporary tables.

At block 929, the billing engine checks whether there are further billing cycles to process. If so, it continues with the next billing cycle for the same site, block 919. If there are no further billing cycles for this particular site, the system checks whether there are other sites for which utility information reports are to be generated. If so, at block 931 the system returns and retrieves channel information for the next site, block 915. Otherwise, if the system is done generating reports for sites, the system at block 933 generates the report footer if any, preferably utilizing HTML.

Several tables are used to internally store data in order to determine the particular rules to be applied, as well as to provide other information that is utilized in making calculations by the billing engine. By way of example, such tables could include information relating to peak periods, holidays, bill rates or tariff information, factor information for each line item, and criteria for billing factors. Additional tables may be utilized by the billing engine as working tables, such as a bill token information table, a bill period date table, and a billing item work table. Examples of these tables follow. The examples are not to be taken as limitative. Moreover, although the information is presented in tables, it may be implemented in a number of varieties of ways. Additionally, other information could be represented in tables if preferred. Not all of the information need be in a table, and additional or a subset of information in the tables could be provided if preferred for a particular implementation.

Table 1 shows one example format for storing period information relating to peakness: season, off-peak, on-peak and mid-peak times.

TABLE 1

| Column | Datatype | Description |
|---|---|---|
| peakness_id | NUMBER(11) | Unique period identifier |
| wholesaler_id | NUMBER(11) | Unique identifier for the wholesaler for which this tariff |
| | | applies |
| utility_id | NUMBER(11) | Unique identifier for the utility for which this tariff applies |
| peakness_name | VARCHAR2(40) | Description of the period defined by record |
| season | VARCHAR2(1) | The season of the period ‘W’ - winter, ‘S’ - summer, ‘P’ - |
| | | partial season |
| start_dt | DATE | The start date for the period defined |
| end_dt | DATE | The end date for the period defined |
| holiday_status_cd | VARCHAR2(30) | Value to determine if holiday information is pertinent to |
| | | period. “I” - include holiday, ‘E’ - exclude holiday, NULL - |
| | | holidays not pertinent |
| sql_where_clause | VARCHAR2(2000) | SQL statement that will be used in where clause to define |
| | | period |
| create_nm | VARCHAR2(30) | The user that created the record |
| create_dts | DATE | The date the record was created |
| last_updt_nm | VARCHAR2(30) | The user to last update the record |
| last_updt_dts | DATE | The last date that the record was updated |

Table 2 is a peakness group table, used to group periods of time from the peakness table, table 1. Preferably, a record in the peakness table includes at least one reference in the peakness group table of table 2.

TABLE 2

| Column | Datatype | Description |
|---|---|---|
| peakness_group_id | NUMBER(4) | Peakness group identifier |
| group_desc | VARCHAR2(75) | Description of the group of |
| | | periods |
| group_short_desc | VARCHAR2(30) | Brief description of the group of |
| | | periods |
| peakness_id | NUMBER(11) | Identifier referencing records in |
| | | the peakness table (FK to |
| | | PEAKINESS table) |
| create_nm | VARCHAR2(30) | The user that created the record |
| create_dts | DATE | The date the record was created |
| last_updt_nm | VARCHAR2(30) | The user to last update the |
| | | record |
| last_updt_dts | DATE | The last date that the record |
| | | was updated |

Table 3 is a holiday table and illustrates one example of a table for storing holidays which will be observed for a given utility and wholesaler.

TABLE 3

| Column | Datatype | Description |
|---|---|---|
| holiday_id | NUMBER(11) | Unique identifier for |
| | | holiday record |
| holiday_desc | VARCHAR2(75) | Long description for holiday |
| holiday_short_desc | VARCHAR(30) | Brief description for holiday |
| start_dt | DATE | The start date for the holiday |
| end_dt | DATE | The end date for the holiday |
| utility_id | NUMBER(12) | Unique identifier for the utility |
| | | for which this tariff applies |
| wholesaler_id | NUMBER(4) | Unique identifier for the |
| | | wholesaler for which this tariff |
| | | applies |
| create_nm | VARCHAR(30) | The user that created the record |
| create_dts | DATE | The date the record was created |
| last_updt_nm | VARCHAR2(30) | The user to last update the |
| | | record |
| last_updt_dts | DATE | The last date that the record |
| | | was updated |

Table 4 is a bill rate table and stores tariff information, including a description of the tariff, identifiers of the utility or wholesaler or region for which the tariff applies, as well as identification information.

TABLE 4

| Column | Datatype | Description |
|---|---|---|
| bill_rate_id | NUMBER(4) | Unique bill rate identifier |
| rate_desc | VARCHAR2(75) | Long description of the tariff |
| | | (ex. General Service) |
| rate_short_desc | VARCHAR2(30) | Brief description of a tariff |
| | | (ex. GS) |
| utility_id | NUMBER(11) | Unique identifier for the utility |
| | | for which this tariff applies |
| wholesaler_id | NUMBER(4) | Unique identifier for the |
| | | wholesaler for which this tariff |
| | | applies |
| region_id | NUMBER(12) | Unique identifier for the region |
| | | for which the tariff applies |
| num_passes | NUMBER(2) | The number of passes in |
| | | processing the billing line items |
| create_nm | VARCHAR2(30) | The user that created the record |
| create_dts | DATE | The date the record was created |
| last_updt_nm | VARCHAR2(30) | The user to last update the record |
| last_updt_dts | DATE | The last date that the record |
| | | was updated |

Table 5 is a bill rate line item table, and also stores tariff information. This includes line item information for applying tariffs, such as start and end dates, peaks, and the order in which the rate is to be applied.

TABLE 5

| Column | Datatype | Description |
|---|---|---|
| bill_rate_line_item_id | NUMBER(11) | Unique bill rate line item identifier |
| bill_rate_id | NUMBER(11) | Identifier for bill rate (FK to BILL_RATE table) |
| description | VARCHAR2(75) | Long description of line item |
| short_desc | VARCHAR2(30) | Brief description of line item (displayed on web page) |
| start_dt | DATE | The start date for which this line item will apply |
| end_dt | DATE | The end date for which this line item will apply |
| parent_bill_rate_line_{—} | NUMBER(12) | The bill_rate_line_item of the parent of this line item. If |
| item_id | | there is no parent, this value will be the same as |
| | | bill_rate_line_item_id |
| token | VARCHAR2(20) | If present, this identifies that the value for this line item |
| | | needs to go into the bill_token table identified by token |
| peakness_group_id | NUMBER(12) | Identifier for peakness group (FK to PEAKNESS_GROUP) |
| | | table. This will identify the sql add to the where clause for |
| | | this line item based on period of time. |
| pass_nbr | NUMBER(2) | The number of the pass that this line item should be |
| | | processed on. This number should not be greater then the |
| | | num_passess column in the BILL_RATE table |
| display_order_nbr | NUMBER(4) | This value determines within parent_bill_rate_line_item_id |
| | | the order in which the item will be displayed on the web |
| | | page. |
| identation_level | NUMBER(1) | For future use |
| presentation_tag | VARCHAR2(2000) | Used to set display attributes on the web page |
| visible_cd | VARCHAR2(1) | Determines if line item is displayed on web page. ‘Y’ - line |
| | | item is displayed. ‘N’ - line item is not displayed |
| proration_cd | VARCHAR2(1) | Determines if proration is used for this line item. ‘Y’ or |
| | | ‘N’ |
| units | VARCHAR2(20) | Value that is displayed on the web page to identify the units |
| | | for this line time. (ex. KWh, kW, kVar, etc.) |
| sql_or_calc | VARCHAR2(1) | For future use. |
| value_token | VARCHAR2(20) | For future use. |
| factor | NUMBER(10, 5) | The value to be used for factor if there is no criteria and |
| | | only one factor can apply for this line item. |
| sql_select_clause | VARCHAR2(2000) | The select part of the SQL to be used for the line item |
| sql_from_clause | VARCHAR2(255) | Not currently used |
| sql_where_clause | VARCHAR2(2000) | The where part of the SQL to be used for the line item |
| create_nm | VARCHAR2(30) | The user that created the record |
| create_dts | DATE | The date the record was created |
| last_updt_nm | VARCHAR2(30) | The user to last update the record |
| last_updt_dts | DATE | The last date that the record was updated |
| quantity_token | VARCHAR2(200) | If the display value for quantity is tied to a data token for |
| | | this line item, the token identifier is stored here. |
| total_flag | VARCHAR2(1) | For future use. |
| rate_proration_cd | VARCHAR2(1) | For future use. |
| factor_token | VARCHAR2(20) | If the factor for this line item is stored as a data token, the |
| | | data token identifier is stored here. |
| attr_change | VARCHAR2(20) | Value identifying what attribute change is tied to this |
| | | column |

Table 6 is a bill rate line factor table, and stores bill rate line factor information, to be used with each line item. The primary key is used as a foreign key in the bill factor variable table to determine the criteria that should be met for a factor to apply.

TABLE 6

| Column | Datatype | Description |
|---|---|---|
| bill_rate_line_factor_id | NUMBER(11) | Unique bill rate line item identifier |
| bill_rate_line_item_id | NUMBER(11) | Identifier for bill rate_line_item (FK to |
| | | BILL_RATE_LINE_ITEM table) |
| description | VARCHAR2(75) | Description of the factor |
| short_desc | VARCHAR2(30) | Short description for the factor |
| start_dts | DATE | The starting date for which the factor will apply |
| end_dts | DATE | The ending date for which the factor will apply |
| factor | NUMBER(14, 7) | The value for the factor |
| create_nm | VARCHAR2(30) | The user that created the record |
| create_dts | DATE | The date the record was created |
| last_updt_nm | VARCHAR2(30) | The user to last update the record |
| last_updt_dts | DATE | The last date that the record was updated |

Table 7 is the billing factor variable table, storing the criteria for a billing factor. A given factor can have multiple criteria to meet in order for that factor to apply to a billing item. Such information includes, for example, minimum and maximum values for the factor to apply.

TABLE 7

| Column | Datatype | Description |
|---|---|---|
| bill_factor_vars_id | NUMBER(11) | Unique bill_factor_vars identifier |
| bill_rate_line_factor_id | NUMBER(11) | Identifier for bill rate_line_factor (FK to |
| | | BILL_RATE_LINE_FACTOR table) |
| qualifier_column | VARCHAR2(256) | Defines the column whose criteria is being evaluated in |
| | | chan_channel |
| qualifier_min | NUMBER(11) | The minimum value for the factor to apply |
| qualifier_max | NUMBER(11) | The maximum value for the factor to apply |
| create_nm | VARCHAR2(30) | The user that created the record |
| create_dts | DATE | The date the record was created |
| last_updt_nm | VARCHAR2(30) | The use to last update the record |
| last_updt_dts | DATE | The last date that the record was updated |

Tables 8, 9 and 10 are temporary working tables; the bill token table, the bill engine dates, and the temporary bill engine tables, respectively. Table 8 is utilized to store billing token information that may be used to generate a cost estimate.

TABLE 8

| Column | Datatype | Description |
|---|---|---|
| session_id | VARCHAR2(20) | Identifier for user session |
| identifier | VARCHAR2(30) | The token identifier |
| value | NUMBER(14, 6) | The numeric value associated with a |
| | | token |
| value_date | DATE | The date value associated with a token |
| value_string | VARCHAR2(30) | The character value associated with |
| | | token |
| static_cd | VARCHAR2(1) | Determines if record is to be deleted |
| | | after every billing cycle is calculated as |
| | | opposed to being deleted after a site |
| | | has been processed. ‘Y’ - do not delete |
| | | record after cycle processing |

Table 9 includes the bill engine dates, and is used as temporary working table during processing to store start and end date for the periods that the cost estimation report will display.

TABLE 9

| Column | Datatype | Description |
|---|---|---|
| start_dt | DATE | Billing period start date |
| end_dt | DATE | Billing period end date |

Table 10 is the temporary billing engine table, utilized as temporary working table during processing to store and process billing items. It includes information such as description of the bill rate line item, display attributes on the web page, proration values, units to be displayed (for example, KWh, kW, kVar), the start and end dates for this line item, the identifier for the peakness group, number of pass for which this line item should be processed, various quantities, and various values.

TABLE 10

| Column | Datatype | Description |
|---|---|---|
| bill_rate_line_item_id | NUMBER(11) | Unique identifier for the bill rate line item |
| description | VARCHAR2(75) | Description of the bill rate line item |
| short_description | VARCHAR2(30) | Short description of the bill rate line item |
| identation_level | NUMBER(1) | For future use |
| presentation_tag | VARCHAR2(2000) | Used to set display attributes on the web page |
| proration_flag | VARCHAR2(1) | Determines if proration is used for this line item. ‘Y’ or |
| | | ‘N’ |
| proration_value | NUMBER(10, 5) | Proration value |
| proration_text | VARCHAR2(60) | Value that is displayed on the web passage to identify the |
| | | units for this line time. 9 ex. KWh, KW, kVar, etc.) |
| visible_flag | VARCHAR2(1) | Determines if line item is displayed on web page. ‘Y’- |
| | | line item is displayed. ‘N’ - line item is not displayed |
| start_dts | DATE | The start date for which this line item will apply |
| end_dts | DATE | The end date for which this line item will apply |
| peakness_group_id | NUMBER(4) | Identifier for peakness group (FK to PEAKNESS_GROUP) |
| | | table. This will identify the sql add to the where clause for |
| | | this line item based on period of time. |
| parent_id | NUMBER(11) | The bill_rate_line_item of the parent of this line item. If |
| | | there is no parent, this value will be the same as |
| | | bill_rate_line_item_id |
| token | VARCHAR2(20) | If present, this identifies that the value for this line item |
| | | needs to go into the bill_token table identified by token |
| pass_number | NUMBER(2) | The number of the pass that this line item should be |
| | | processed on. This number should not be greater then the |
| | | num_passes column in the BILL_RATE table |
| quantity_token | VARCHAR2(200) | If the display value for quantify is tied to a data token for |
| | | this line item, the token identifier is stored here. |
| quantity | NUMBER(14, 6) | The value from the quantity token |
| value | NUMBER(14, 6) | The total value for the line item |
| factor | NUMBER(14, 7) | The factor to be used by the line item |
| display_order | NUMBER(4, 1) | This value determines within parent_bill_rate_item id the |
| | | order in which the item will be displayed on the web page. |
| total | NUMBER(14, 6) | For future use |
| total_flag | VARCHAR2(1) | For future use |
| sql_select_clause | VARCHAR2(2000) | The select part of the SQL to be used for the line item |
| sql_where_clause | VARCHAR2(2000) | The where part of the SQL to be used for the line item |
| units | VARCHAR2(20) | Value that is displayed on the web page to identify the units |
| | | for this line time. (ex. KWh, kW, kVar, etc.) |
| factor_token | VARCHAR2(20) | If the factor for this line item is stored as a data token, the |
| | | data token identifier is stored here. |
| attr_change | VARCHAR2(20) | Value identifying what attribute change is tied to this |
| | | column |
| change_percent | NUMBER(10, 4) | The attribute change percentage |

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the information system may include a general purpose computer, or a specially programmed special purpose computer. Likewise, the billing engine may be a general purpose computer or specially programmed dedicated computer. Either of these may be implemented as a distributed computer system rather than a single computer. Similarly, the communications network which is illustrated as the World Wide Web or a modem over a POTS line, may include any other method of communicating between computers and/or billing devices. Moreover, the processing could be controlled by a software program on one or more computer system or processors, or could even be partially or wholly implemented in hardware, or could be partly embedded within various devices used for billing.

This invention is not limited to particular types of meter devices. It is intended to be used with any standard meter device from which meter information can be collected. Further, the invention is not limited to particular protocols for communicating with meter devices. Any appropriate communication protocol may be used with the meter devices. Additionally, the invention is not limited to meter information obtained directly from meter devices. As discussed above, meter information collected by the utility for generating bills may further be collected indirectly and used by the billing engine. Likewise, meter information collected or captured for any purpose may be used by the billing engine.

The user displays are discussed in connection with HTML display format. Although HTML is the preferred display format, it is possible to utilize alternative display formats for displaying reports and obtaining user instructions. The invention has been discussed in connection with a particular example of energy usage. However, the principals apply equally to other utilities which are measured, such as water, gas, sewer, and telephone. Naturally, the units of measurement which are relevant will be different, as well as line items and rate structures.

Further, this invention has been discussed as if it is made available by a utility with numerous customers. The invention may be used by a single customer, if preferred. Also, the invention may be utilized by customers with single sites.

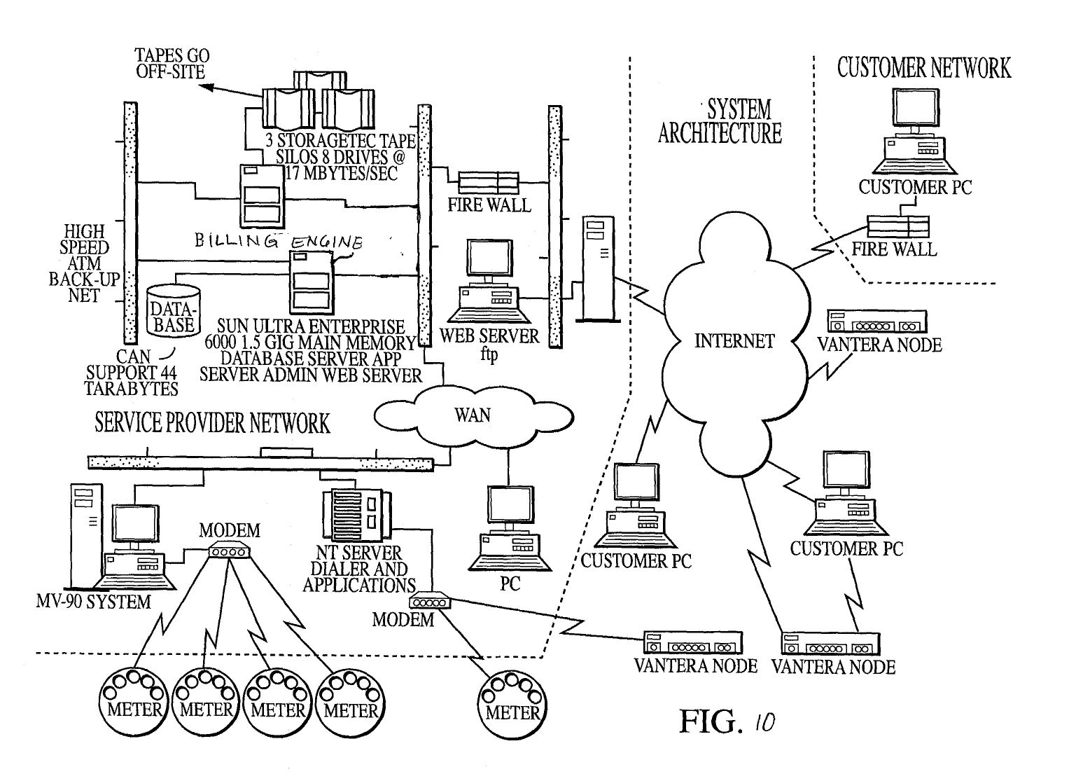

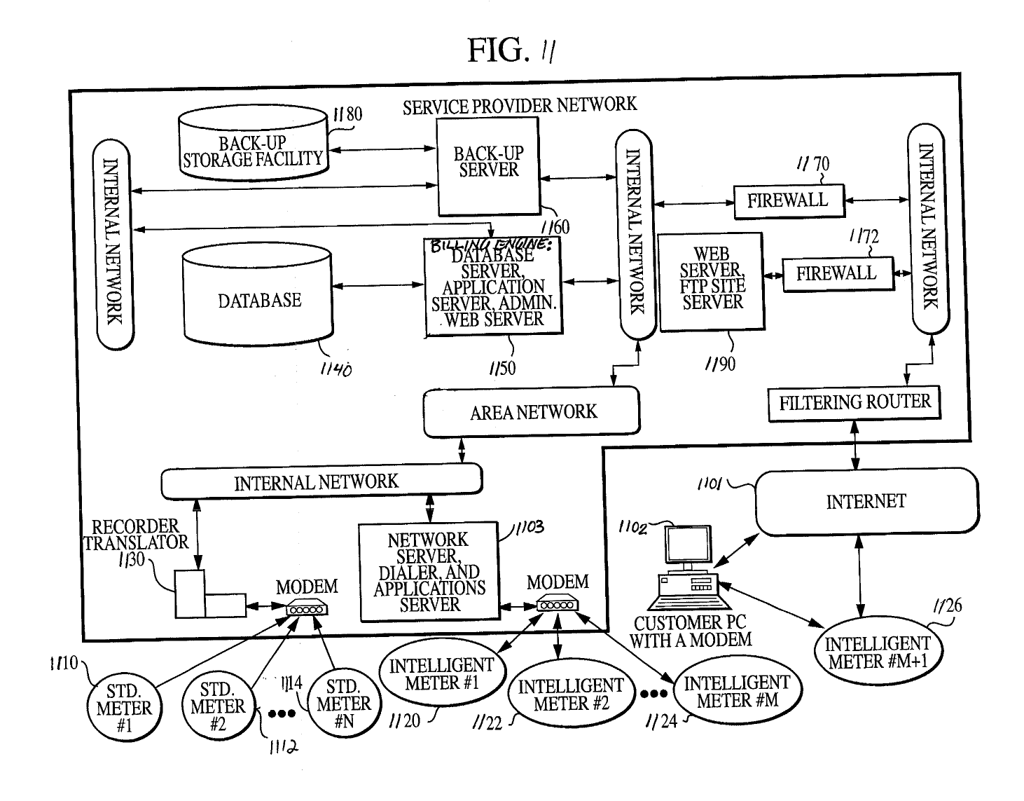

FIG. 10 is a schematic illustration of the architecture which may be used in connection with one or more embodiments of the inventions. FIG. 11 is a schematic derived from FIG. 10, but having more generalized components. The system relies on the integration of various components including, as appropriate and/or if desired, hardware and software servers, node and recorder information acquisition, applications software, database engines, firewall and SSL security, production back-up systems, and/or applications interface software. The configuration is network-based and optionally utilizes the Internet as an exemplary primary interface with the customer for information delivery.

In the architecture illustrated in FIGS. 10 and 11, the customer gathers or collects the information, which is then compiled into the system and then is presented to the customer or user. FIG. 11 depicts end-use collection devices including standard utility meters 1110, 1112, 1114, and/or intelligent meters 1120, 1122, 1124, 1126. Such standard utility meters 1110 may include, for example, Power Measurement's 7700 ION load profile data recorder. Such intelligent meters may include, for example, Hewlett Packard's Vantera nodes. The system has the ability to dial out to these standard meters 1110, 1112, 1114 and/or intelligent meters 1120, 1122, 1124, 1126 using, for example, either public switched telephone network (PSTN), and/or the Internet with Internet Protocol (IP) addressing, to Vantera nodes. In addition to or alternatively, other standard end-use collection devices may be used.

The primary function of the meter information or the recorder information is to capture information from a measurement device and to store the information. Once the information is stored, the information is captured from the recorder. An intelligent recorder/meter, such as a Vantera-type node, has all the capabilities of a standard load data recorder. That is, the Vantera-type node, in addition to collecting the information, can, for example, send control signals. By way of illustration, the Vantera-type node or other intelligent node may include a predetermined value that indicates “above some level, take some action,” for example, send a signal. In addition, the Vantera-type node can actually serve up, or react responsive to, its own web page. So, the customer can dial into the web page directly accessing the Vantera-type node, instead of dialing into the service provider network to access the web page.

The Vantera-type node is, for example, a PC and has, for example, a megabyte of flash memory. One of the applications that is on the Vantera-type node, is a web-serving device. So, the Vantera node, itself, can be accessed directly through, for example, a modem or indirectly through the Internet 1101. Normally, the information on the Vantera-type node is accessible via telephone or other standard communication technique. The Vantera-type technology provides the capability of accessing over, for example, Ethernet, or other networks. However, some customers may not like such access, either because they have to interact with their own information technology (IT) departments, or they just feel there might be a security issue. A PCMCIA may alternatively be provided in the Vantera-type node itself, and may be used to access the nodes.

A Vantera-type node is called, for example, every hour, to obtain the information just as any other meter or recorder. However, if the customer wants the information in real-time, where the customer wants to see specifically what is presently happening, the customer may dial the node up itself and initiate a communication session with the node via the direct phone line into the node using, for example, the standard web browser in the node. No contact with the Internet 1101 is necessary.

Every Vantera-type node has its own IP address. The Vantera-type node indicates its IP address or similar location information to a customer or sends back to the customer a URL or other locator for the node. The customer then accesses that web server on the Vantera-type node itself to see the information, for example, in real-time. A customer may look at the data history to the extent permitted by the amount of available storage on the node itself. However, if the customer wants to see something current, or over the past couple of days, the customer may take a look at that information in this manner. After the customer has finished accessing the Vantera-type node and read the node for utility data when the customer is off-hook, the collected data is available for analysis. Thus, the present invention advantageously permits optional real-time access to users, while also collecting the information over time, without losing the information, for analysis.

The information that is monitored includes, for example, process-related information. For example, the process-related information may include energy or gas consumption, in terms of kilowatt-hours (kWh) on the electric side, or million cubic feet (Mcf) on the gas side. Other types of process-related data may also be used where the process data may advantageously be combined, for example, electricity, natural gas, gasoline, cable television, band width (copper, optical fiber, etc.), telecommunications, short distance service, long distance service, water, Internet usage, radio usage, cellular usage, digital usage, satellite usage, and the like.

Plainly, the instant invention may be adapted to any resource usage that may be monitored. Further, process-related data, as given by way of example above, may be aggregated among multiple users to present to a resource provider a larger than otherwise possible consumer block, which may demand price concessions because of the quantity of resource to be sold to the consumer block. Advantageously, users having complementary resource usage may aggregate their usage requirements so as to provide substantially linear usage requirement over time to a resource provider.

Typically, a standard fuel unit measurement in, for example, million cubic feet may be accessed via a standard recorder translator 1130, such as MV-90, manufactured by Utility Translation Systems. By way of illustration, MV-90 is a universal recorder translator that allows utilities to retrieve and analyze data from metering equipment of substantially all major manufacturers for revenue billing, load research, and system analysis applications. A standard recorder translator, such as, the MV-90 system queries almost any type of low data recorder that is in the field today used by just about every electric utility. This provides the ability to look at a variety of end-use collection devices that are used by utilities. Collection device interrogation may occur at any desired interval, for example, hourly or daily. One specific process for customers is that, for example, every hour a phone call to the recorder is made to access the previous hour's energy or load information. Other interval collections may also be used.

The data is returned to the MV-90, for example, which serves as a retrieval and translation mechanism in a sense that it brings back the information as the recorder translates the information into engineering units, such as KWh, a standard unit of measurement for electricity or kr, a standard unit of measurement for oil, for example. The MV-90, for example, collects information that is a component of energy usage or other form of chargeable usage, and may then optionally deposit that information via an FTP file transfer to a database 1140.

The database 1140 is on a standard server, for example, a small Sun Sparc 1150 or other remote location. The database 1140 is optionally an MSQL, MYSQL, mini sequel server MiniSQL, or Oracle. Information is stored in the database 1140, presented to customers, and optionally stored and backed up by a back-up server 1160, periodically or aperiodically, for example, every night along with all other data in the servers that are behind the corporate firewall 1170 into a back-up storage facility 1180. Back-up storage facility 1180 comprises, for example, one of three tape silos that are also used to back up the entire network every night. Data security of customers data is advantageously maintained. The information flow for the Vantera-type node information is similar. In general, the data that was run through MV-90, for example, will eventually get stored, for example, on a platform which may, for example be UNIX-based.

The database 1140 is in, for example, a UNIX format, but other standard data formats may also be used. Windows NT, for example, is used to access the HP Vantera-type products, but other standard operating systems may also be used. But, eventually that data then gets translated also and drops into the UNIX database, via, for example, a UNIX translator, or other data format translator, if needed. A file format may be created that sets out for a given timetable load information, time, an identifier, a psuedo identifier such as a name or a mute number, and/or the actual data intervals of information. Once it is read by the dialer on the NT side, the information then may be sent, for example, by file transfer protocol (“FTP'd”) or other transfer protocol in the same or similar file format as comes out of for example, an MV-90 such that it is transparent to the database 1140 where the information is coming from. All the information then gets stored in the MSQL-type database, or optionally, an Oracle-type database. Optionally, database 1140 includes a conversion system capable of receiving data in various standard formats.

On the information distribution side from the customer's perspective, the customer may access the public Internet or other suitable network and look at its specific information at any time from any location as long as it has Internet or other suitable access. For example, the customer opens its standard web browser, goes to the address that is specified for its load data, and optionally fills out a user ID to log on, and a password to identify it as the specific user or the specific customer of that particular information. This information is entered to access the entire set of load data, or a portion thereof, collected over time for at least one of the site or sites that may be remotely located from each other, for example, in different states and/or countries of the world, particular or relevant to that customer.

Information may be, for example, collected since January 1 of a given year and can go back all the way to January 1 of the previous year. Once this information is accessible, it may be presented in whatever time period the customer wishes to see or analyze in terms of a load profile of that information showing load characteristics, including amount, duration, periodicity, standard deviations of usage on a periodic or aperiodic basis, and the like.

Optional first firewall 1170 is used to secure at least the database 1140. The web server and/or FTP server 1190 are optionally outside the firewall. Optionally, customers cannot directly access database 1140 itself. Thus, for example, the customer issues a query to the web server 1190, which then calls for or retrieves the data, which in turn transmits the data through the application server 1150 (optionally, the same server as the database server) which is then presented to the customer.

Optionally, security of the networks is as tight as possible such that the data, not only customer data, but any information which is beyond the firewall 1170 is always protected against any kind of potential intrusion. Thus, data from the Web server 1190 must be accessed through optional first firewall 1170 as well.

Optionally, a second firewall 1172 may be placed in front of the web server 1190. The customer or other authorized user (“customer”), once at the web site, can move or navigate around to the various pages that comprise the instant invention. The customer, and, indeed, multiple customers concurrently can look at the same information. Advantageously, having this system on the Internet enables customers at various locations throughout an area of the country or the world, to actually come to the same site at the same time and enter into a discussion or talk group as to what they are seeing, what it means, and maybe what they can do with that information.

The present invention, therefore, helps troubleshooting, by providing an understanding, for example, of the quality of energy or the electric service that is being provided, such as, voltage fluctuations and/or momentary spikes. Customers thus are provided the ability to do analysis, e.g., power quality analysis, over the Internet or other suitable network that is able to capture their resource usage in various different forms, for example, natural gas, gasoline, electricity, propane, band width, cable television signals, cellular communications signals, local telephone service, long distance telephone service, Internet usage, satellite signals, and the like. So, for example, a consultant such as an engineer, may be in Del. and the site may be in Ohio. The engineer may look at the information, do analysis, and perhaps even resolve an issue without ever going to the site. The types of information that the customer may see, include, for example, the load in energy, the actual building layout/structure, historical bills, and/or a forecasting component that helps forecast the amount of energy a customer may use based upon a forecast for a given location or a given customer site. Optionally, the instant invention includes a front end that displays news and weather and industry-specific information so that a particular customer may track the customer's particular industry, for example, by standard linking to public Internet sites.

Advantageously, the customer is provided the capability of downloading any piece, part or all of the data that the instant invention has collected or calculated for it. So, any piece of stored load information is, optionally, always available to the customer, for example, by simply requesting a flat ASCII file download feature. Thus, if the customer requests such information, for example, from January through March of a particular year, the customer will receive all of that information, optionally along with associated price estimates.

The standard “File, Save as” facility in standard browsers may be used to save the information, for example, to a local PC, and then imported into a standard spreadsheet or database for analysis. A further advantage of the present invention is that all of the data is firewalled off from anybody making intrusion of getting into or accessing the data.

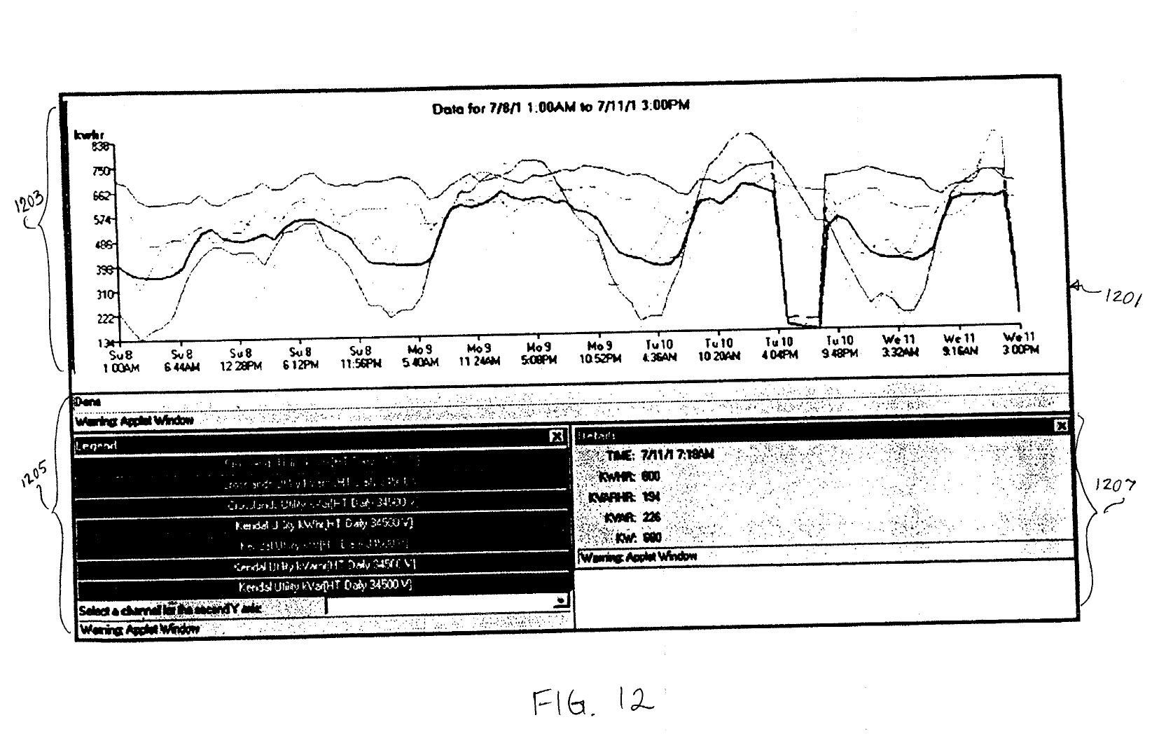

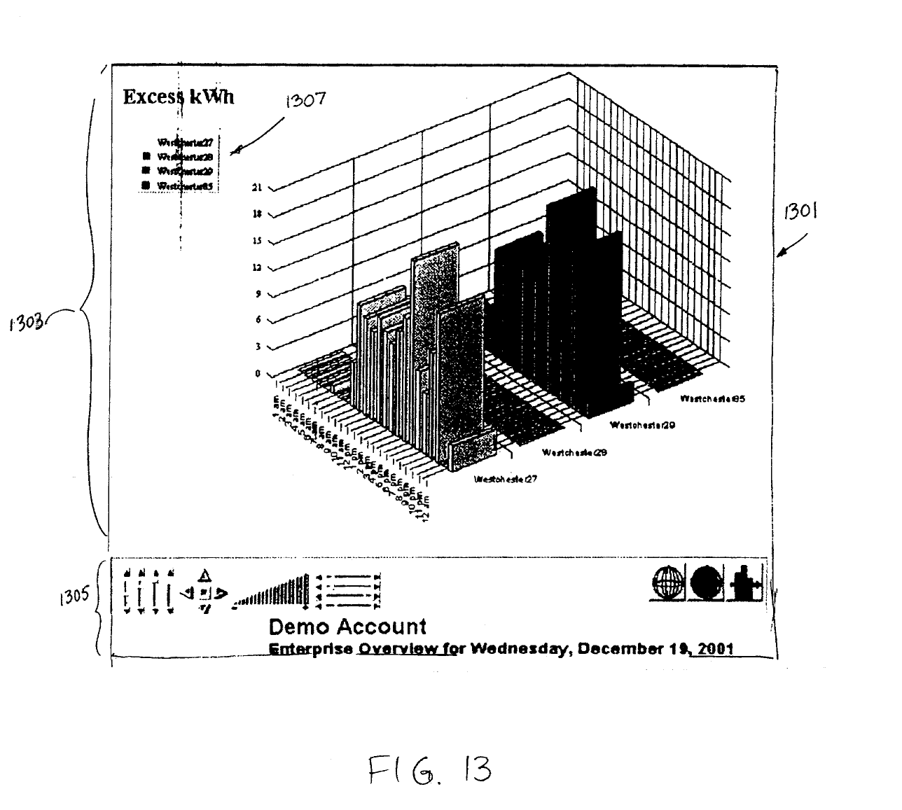

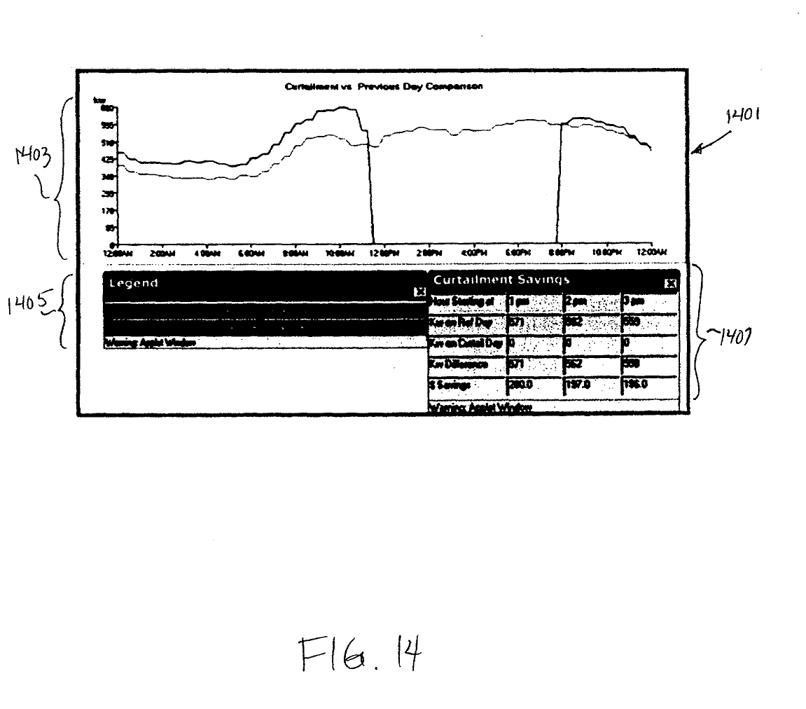

FIGS. 12-14 illustrate optional graphical displays for use in presenting the reports. The reports may be presented in graphical and/or textual form. FIG. 12 illustrates one example of a graphical display 1201. The information is represented in line graph portion 1203 of the display. A legend portion 1205 of the display provides a key to the line graph portion 1203. A detail portion 1207 is included in the display, so that the user can select a segment of the line graph portion 1203 and display the underlying information in textual format. FIG. 13 illustrates another example of a graphical display. It includes a bar graph portion 1303, as well as a legend portion 1307. The bar graph portion 1303, may be adjusted by the user via the control portion 1305. FIG. 14 illustrates an example of a graphical display 1401, here in connection with the curtailment option. The display 1401 includes a line graph portion 1401, a legend portion 1405, and a detail portion 1407. The detail portion 1407 is FIG. 14 provides information relating to curtailment savings.

The following is a glossary defining terms relevant to the invention:

t Glossary

| | |
|---|---|
| Aggregation | Amassing volumes of energy from different sources to create a larger |
| | “package”. |
| Ampere | The unit of measurement of electrical current produced in a circuit by 1 volt |
| | acting through a resistance of 1 ohm. |
| Baseload | The minimum amount of electric power delivered or required over a given |
| | period of time at a steady rate. |
| Btu (British | The standard unit for measuring the quantity of heat energy (e.g., heat content |
| Thermal Unit) | of fuel); one Btu is the amount of heat necessary to increase the temperature of |
| | one pound of water by one degree Fahrenheit (3,412 Btu's = 1 kWh). |
| Capacitor | A device that improves the efficiency of the flow of electricity through |
| | distribution lines by reducing energy losses. |
| Capacity | The amount of electric power delivered or required for which a generator, |
| | turbine, transformer, transmission circuit, station, or system is rated by the |
| | manufacturer. |
| Capacity Charge | An element in a two-part pricing method used in capacity transactions (energy |
| | charge is the other element); the capacity charge, sometimes called Demand |
| | Charge, is assessed on the amount of capacity being purchased. |
| Circuit | A conductor or a system of conductors through which electric current flows. |
| Cogenerator | A generating facility that produces electricity and another form of useful |
| | thermal energy (such as heat or steam) used for industrial, commercial, heating, |
| | or cooling purposes; to receive status as a qualifying facility (QF) under the |
| | Public Utility Regulatory Policies Act (PURPA), the facility must produce |
| | electric energy and another form of useful thermal energy through the |
| | sequential use of energy and meet certain ownership, operating, and efficiency |
| | criteria established by the Federal Energy Regulatory Commission (FERC) |
| | (Code of Federal Regulations, Title 18, Part 292). |
| Coincidental | The sum of two or more demands that occur in the same time interval. |
| Demand | |
| Coincidental Peak | The sum of two or more peak loads that occur in the same time interval. |
| Load | |
| Combined Cycle | An electric generating technology in which electricity is produced from |
| | otherwise lost waste heat exiting from one or more gas (combustion) turbines; |
| | the exiting heat is routed to a conventional boiler or to a heat recovery steam |
| | generator for use by a steam turbine in the production of electricity; this process |
| | increases the efficiency of the electric generating unit. |
| Current (Electric) | A flow of electrons in an electrical conductor; the strength or rate of movement |
| | of the electricity is measured in amperes. |
| Demand (Electric) | The rate at which electric energy is delivered to or by a system, part of a |
| | system, or piece of equipment, at a given instant or averaged over any |
| | designated period of time. |
| Direct Access | An arrangement in which customers can purchase electricity directly from any |
| | supplier in the competitive market, using the transmission and distribution lines |
| | of electric utilities to transport the electricity. |
| Disco | Short for distribution company; a type of company that distributes electricity to |
| | customers, but does not provide generation or transmission services. |
| Distribution | The facilities of the electric system that deliver electricity from substations to |
| | customers; the distribution system “steps down” power from high voltage |
| | transmission lines to a level that can be used in homes and businesses. |
| Distribution Line | A line, system, or circuit for distributing power from a transmission system to a |
| | customer; these lines operate at less than 69,000 volts. |
| EDC | Electric Distribution Company. |
| Energy | The capacity for doing work as measured by the capability of doing work |
| | (potential energy) or the conversion of this capability to motion (kinetic |
| | energy); energy has several forms, some of which are easily convertible and can |
| | be changed to another form useful for work; most of the world's convertible |
| | energy comes from fossil fuels that are burned to produce heat, which is then |
| | used as a transfer medium to mechanical or other means to accomplish tasks; |
| | electrical energy is usually measured in kilowatt-hours, while heat energy is |
| | usually measured in British thermal units (Btu's). |
| Energy Charge | That portion of the charge for electric service based on the electric energy |
| | (kWh) consumed or billed. |
| Federal Energy | A federal agency established in 1977, which regulates the wholesale electricity |
| Regulatory | market (i.e., power and transmission sales and service between utilities and |
| Commission (FERC) | between utilities and nonutility generators); a quasi-independent regulatory |
| | agency within the Department of Energy having jurisdiction over interstate |
| | electricity sales, wholesale electric rates, hydroelectric licensing, natural gas |
| | pricing, oil pipeline rates, and gas pipeline certification. |
| Forced Outage | The shutdown of a generating unit, transmission line, or other facility for |
| | emergency reasons or a condition in which the generating equipment is |
| | unavailable for load because of unanticipated breakdown. |
| Genco | Short for generating company; a type of company that is solely engaged in the |
| | business of generating electricity. |
| Generating Station | A building where electricity is made; this term is used interchangeably with |
| | “power plant”. |
| Gigawatt | One billion watts, useful for describing the capacity of large electrical systems. |
| Green Pricing | A term used to market electricity that is produced, at least in part, through |
| | renewable technologies; green pricing programs allow customers to support |
| | renewable programs, usually at a premium. |
| High Tension or | Lines that carry the highest distribution Primary voltage; they are usually |
| Distribution Feeder | located at the uppermost position of the utility pole. |
| (Primaries) | |
| Horsepower | A unit for measuring the power of motors or engines; 1 horsepower equals 746 |
| | watts. However, for all practical purposes, 1 horsepower is considered 1,000 |
| | watts or 1 kilowatt (figure considers starting load and motor inefficiency); for |
| | example, a 3-horsepower motor would be rated at approximately 3,000 watts or |
| | 3 kW, so a 1/3-horsepower motor would be rated at approximately 333 watts. |
| Host Utility | The local franchised utility that serves retail customers in its service territory. |
| Independent Power | A nonutility power generator that is not a regulated utility, government agency, |
| Producer (IPP) | or Qualifying Facility under the Public Utility Regulatory Practices Act of 1978 |
| | (PURPA); IPPs sell the power they generate in the wholesale market, typically |
| | to electric utilities; the terms of power purchase agreements between IPPs and |
| | power purchasers are subject to approval by the Federal Energy Regulatory |
| | Commission (FERC). |
| Interconnection | A connection between two electrical systems permitting the transfer of electric |
| System | energy in either direction. |
| Intermediate Load | The range from base load to a point between base load and peak; this point may |
| (Electric System) | be the midpoint, a percent of the peak load, or the load over a specified time |
| | period. |
| Interruptible Load | Refers to program activities that, according to contractual arrangements, can |
| | interrupt consumer load at times of seasonal peak load by direct control of the |
| | utility system operator or by action of the consumer at the direct request of the |
| | system operator: it usually involves commercial and industrial consumers; in |
| | some instances the load reduction may be affected by direct action of the |
| | system operator (remote tripping) after notice to the consumer in accordance |
| | with contractual provisions: for example, loads that can be interrupted to fulfill |
| | planning or operation reserve requirements should be reported as Interruptible |
| | Load; Interruptible Load as defined here excludes Direct Load Control and |
| | Other Load Management; Interruptible Load, as reported here, is synonymous |
| | with Interruptible Demand reported to the North American Electric Reliability |
| | Council on the voluntary Office of Energy Emergency Operations Form GE- |
| | 411, “Coordinated Regional Bulk Power Supply Program Report,”with the |
| | exception that annual peak load effects are reported on Form EIA-861 and |
| | seasonal (i.e., summer and winter) peak load effects are reported on Form 0E- |
| | 411). |
| Kilovolt (kY) | One thousand volts. |
| Kilowatt (kW) | One thousand watts. |
| Kilowatt-hour | The basic unit of electric energy equal to 1 kilowatt or 1,000 watts of power |
| (kWh) | used for one hour; the amount of power the customer uses is measured in |
| | kilowatt-hours (100 watts × 10 hours) or 1,000 watts used in 10 hours. |
| kVAR | kVAR (kilovars) is the typical unit of measure for “reactive power” (as |
| | compared to “real power,” which is typically measured in kW); reactive power |
| | is the portion of electricity that establishes and sustains the electric and |
| | magnetic fields of alternating-current equipment; reactive power must be |
| | supplied to most types of magnetic equipment, such as motors and |
| | transformers; reactive power can be supplied by generators, synchronous |
| | condensers, or electrostatic equipment such as capacitors. |
| kVARh | The basic unit of reactive power equal to 1 kVAR used for one hour. |
| LDC | Local distribution company. |
| Load (Electric) | The amount of electric power delivered or required at any specific point or |
| | points on a system; the requirement originates at the customer's energy- |
| | consuming equipment. |
| Load Factor | Ratio of annual energy usage to maximum summer demand: |
| (Annual) | $Percent Load Factor \frac{Annual Energy Usage}{kW \times 8 \text{,} 760 hours} \times 100$ |
| Load Factor | Ratio of energy usage to maximum demand during the month: |
| (Monthly) | $Percent Load Factor \frac{kWh \times 100}{kW \div ( demand \times 740 hours )} \times 100$ |
| Market-based Rates | Rates for power or electric services that are established in an unregulated, |
| | competitive market; these rates can be established through competitive bidding |
| | or through negotiations between the buyer and seller, rather than set by a |
| | regulator: as portions of the electric industry become less regulated, market |
| | prices are increasingly important for making business decisions. |
| Megawatt | One million watts or 1,000 kilowatts. |
| Meter Board | The board on which the meter and associated equipment are mounted. |
| Network | A system of transmission and distribution lines cross-connected and operated to |
| | permit multiple power supply to any principal point on it; a network is usually |
| | installed in urban areas; it makes it possible to restore power quickly to |
| | customers by switching them to another circuit. |
| Non-coincidental | The sum of two or more peak loads on individual systems that do not occur in |
| Peak Load | the same time interval; meaningful only when considering loads within a |
| | limited period of time, such as a day, week, month, a heating or cooling season, |
| | and usually for not more than 1 year. |
| Non-Firm Power | Power or power-producing capacity supplied or available under a commitment |
| | having limited or no assured availability. |
| Non-Utility | A term coined to describe Qualifying Facilities, independent power producers, |
| Generator (NUG) | exempt wholesale generators, and any other company in the power generation |
| | business, which has been exempted from traditional utility regulation; some |
| | NUG facilities are built by users primarily for their own energy needs; other |
| | NUG plants are built specifically to sell power to utilities under long-term |
| | contracts: in the last five years, nonutility generators have constructed over 50 |
| | percent of new generation capacity. |
| Ohm | The unit of measurement of electrical resistance: the resistance of a circuit in |
| | which a potential difference of 1 volt produces a current of 1 ampere. |
| Open Transmission | Enables all participants in the wholesale market equal access to transmission |
| Access | service, as long as capacity is available, with the objective of creating a more |
| | competitive wholesale power market; the Energy Policy Act of 1992 gave the |
| | Federal Energy Regulatory Commission (FERC) authority to order utilities to |
| | provide transmission access to third parties in the wholesale electricity market. |
| Outage | The period during which a generating unit, transmission line, or other facility is |
| | out of service. |
| Peak Demand | The maximum load during a specified period of time. |
| Power | The rate at which energy is transferred; electrical energy is usually measured in |
| | watts; also used for a measurement of capacity. |
| Power Broker | An individual, who arranges power sales between other parties, but never |
| | actually owns the power; power brokers are not required to register with the |
| | Federal Energy Regulatory Commission. |
| Power Grid | A network of power lines and associated equipment used to transmit and |
| | distribute electricity over a geographic area. |
| Power Marketer | An individual who sells power that it either buys or generates on its own; power |
| | marketers are a type of electricity supplier greatly expanded by the Energy |
| | Policy Act of 1992: sales of electricity by power marketers jumped from near |
| | zero in 1992 to 70 million megawatt hours in 1996; power marketers are |
| | required to be certified by FERC. |
| Power Pool | An association of two or more interconnected electric systems having an |
| | agreement to coordinate operations and planning for improved reliability and |
| | efficiencies. |
| Primary Metering | The primary metering flag indicates that electricity delivered to a customer is |
| | measured in primary voltage. |
| Public Utilities | The state regulatory agency that governs retail utility rates and practices and, in |
| Commission | many cases, issues approvals for the construction of new generation and |
| | transmission facilities: on average, the state commission regulates roughly 90 |
| | percent of a utility's operations. |
| Reliability | The ability to deliver uninterrupted electricity to customers on demand, and to |
| | withstand sudden disturbances such as short circuits or loss of major system |
| | components; this encompasses both the reliability of the generation system and |
| | of the transmission and distribution system. |
| Retail Wheeling | A transmission or distribution service by which utilities deliver electric power |
| | sold by a third party directly to retail customers; this would allow an individual |
| | retail customer to choose his or her electricity supplier, but still receive delivery |
| | using the power lines of the local utility. |
| Scheduled Outage | The shutdown of a generating unit, transmission line, or other facility, for |
| | inspection or maintenance, in accordance with an advance schedule. |
| Spinning Reserve | That reserve generating capacity running at a zero load and synchronized to the |
| | electric system. |
| Standard Industrial | A set of codes developed by the Office of Management and Budget, which |
| Classification (SIC) | categorizes business into groups with similar economic activities: the transition |
| | to NAICS (North American Industry Classification System) began in 1997 and |
| | is supposed to be complete by the end of 2002. |
| Stranded Costs | Costs that were incurred by utilities to serve their customers with the |
| | understanding that state regulatory coniniissions would allow the costs to be |
| | recovered through electric rates; stranded costs can occur either because |
| | particular customers discontinue their use of a service or because such |
| | customers are no longer willing to pay the full cost incurred to provide a |
| | service; potentially stranded costs are the result of decisions that were reviewed |
| | and approved by government regulators and were made by utilities under the |
| | unique regulatory compact with their state and their customers; the Federal |
| | Energy Regulatory Commission has determined that stranded costs, at the |
| | wholesale level, should be paid by electric customers. |
| Transmission Lines | Wires that carry high voltage electricity over long distances from a generating |
| | station to places where electricity is needed; transmission lines are held high |
| | above the ground on transmission towers. |
| Unbundling | Electric service is traditionally provided on a bundled basis, meaning that |
| | generation, transmission and distribution services are provided as a single |
| | package; by unbundling, the package offerings of the various services that |
| | make up traditional utility service are separated into discreet, separately priced |
| | components; an example would be selling electric power distribution as a |
| | separate service without including costs associated with power generation or |
| | transmission services; unbundling could allow the customer to select a different |
| | supplier or source for each of the components required to obtain a product or |
| | service; also referred to as functional unbundling. |
| Volt | A unit of electrical pressure that measures the force or push of electricity; volts |
| | represent pressure, corresponding to the pressure of water in a pipe. |
| Voltage | A measure of the force of moving energy. |
| Voltage Reduction | Any intentional reduction of system voltage by 3 percent or greater for reasons |
| | of maintaining continuity of service of the bulk electric power supply system. |
| Watt (Energy) | A measure of how much electricity an appliance needs: a watt is an electrical |
| | unit of power; this term is commonly used to rate appliances using relatively |
| | small amounts of electricity; there is a mathematical relationship between watts, |
| | volts, and amps: Wattage = Amps × Voltage; for example, a 120-volt, 15-amp |
| | circuit will carry 1,800 watts. |
| Wholesale Wheeling | The process of sending electricity from one utility to another wholesale |
| | purchaser over the transmission lines of an intermediate utility: under the |
| | Energy Policy Act of 1992. utilities are required to provide wholesale |
| | transmission wheeling services to any electric utility, federal power marketing |
| | agency, or any other company generating electric energy for sale in the |
| | wholesale market. |

What is claimed is:

1. A computer implemented method of managing utility information responsive to at least one of usage and estimated usage of utility resources, comprising the steps of:
(A) Storing information regarding at least one user, at least one utility relating to the at least one user, and a plurality of rules that may be applied by the at least one utility for the at least one user in determining the utility information;
(B) Collecting measurement related or estimate related information representative of the at least one of the utility usage and the estimated usage by the at least one user;
(C) Selecting at least one preference representative of a variable utilized in generating the utility information for the at least one user;
(D) Generating the utility information for the at least one user responsive to the at least one preference, the utility information relating to the at least one user, the at least one preference, and the measurement related or estimate related information for the at least one user; and
(E) Displaying a report representative of the utility information utilizing the at least one preference.

2. The method of claim 1, wherein the measurement related or estimate related information is acquired remotely from at least one of: a utility meter, a database of meter information, a periodic reading of a utility meter, and a demand reading of a utility meter.

3. The method of claim 1, wherein the utility resource is power characterized by power component information, and wherein the power component information includes real power, apparent power, and reactive power; and wherein the measurement related or estimate related information comprises at least two of the real power, the apparent power and the reactive power; and wherein said generating step (D) generates the utility information including calculated billing information comprising one another of the at least two of the real power, the apparent and the reactive power.

4. The method of claim 1, wherein the utility resource is power, and the variables include at least one of time period, site, tariff, state tax, city tax, billing cycle, energy usage, location, and curtailment.

5. The method of claim 1, wherein the user comprises at least one of an energy provider and a customer with multiple facilities.

6. The method of claim 1, wherein the report includes actual usage, forecast usage and/or cost estimates, responsive to data input by the user; and wherein the preference reflects at least one of: location, demand, time shift, curtailment participation, extrapolation of current usage, adjustment of current usage, billing period and tariff.

7. The method of claim 1, further comprising the step of, responsive to the at least one preference, providing an estimated forecast of a utility billing statement for the user.

8. The method of claim 1, wherein the report comprises a plurality of sites, and the report includes a summary corresponding to the plurality of sites.

9. The method of claim 1, wherein the report includes at least one line item selected from: delivery charge, service charge, transmission charge, customer charge, distribution charge, computer transmission charge, environmental fund rate, low income fund rate, and power factor adjustment.

10. The method of claim 1, wherein the report has a format resembling a printed billing statement.

11. The method of claim 1, further comprising at least one of components selected from: estimating cost, reporting exceptions, forecasting cost, benchmarking, providing market prices, and analyzing report information; wherein said at least one component utilizes at least one of: the measurement related information, the estimate related information, and the user information.

12. The method of claim 1, further comprising the step of determining, responsive to a user request, an effect on cost of participation in a curtailment program.

13. The method of claim 12, further comprising the step of, if the user selected participation in the curtailment program, verifying that the user curtailed.

14. The method of claim 1, wherein at least one of the measurement related information, the estimate related information, and the user information is stored in at least one table.

15. The method of claim 1, wherein the information stored in the at least one table includes at least one of: peak periods, holidays, bill rates, tariff information, factor information for line items, and billing factor criteria.

16. A computer program device for use in managing utility information responsive to at least one of usage and estimated usage of utility resources, comprising:
(A) At least one computer readable medium;
(B) Instructions, provided on the at least one computer readable medium, for storing information regarding at least one user, at least one utility relating to the at least one user, and a plurality of rules that may be applied by the at least one utility for the at least one user in determining the utility information;
(C) Instructions, provided on the at least one computer readable medium, for collecting measurement related or estimate related information representative of the at least one of the utility usage and the estimated usage by the at least one user;
(D) Instructions, provided on the at least one computer readable medium, for selecting at least one preference representative of a variable utilized in generating the utility information for the at least one user;
(E) Instructions, provided on the at least one computer readable medium, for generating the utility information for the at least one user responsive to the at least one preference, the utility information relating to the at least one user, the at least one preference, and the measurement related or estimate related information for the at least one user; and
(F) Instructions, provided on the at least one computer readable medium, for displaying a report representative of the utility information utilizing the at least one preference.

17. The method of claim 16, wherein the measurement related or estimate related information is acquired remotely from at least one of: a utility meter, a database of meter information, a periodic reading of a utility meter, and a demand reading of a utility meter.

18. The device of claim 16, wherein the utility resource is power characterized by power component information, and wherein the power component information includes real power, apparent power, and reactive power; and wherein the measurement related or estimate related information comprises at least two of the real power, the apparent power and the reactive power; and wherein said generating instructions (E) generate the utility information including calculated billing information comprising one another of the at least two of the real power, the apparent and the reactive power.

19. The device of claim 16, wherein the utility resource is power, and the variables include at least one of time period, site, tariff, state tax, city tax, billing cycle, energy usage, location, and curtailment.

20. The device of claim 16, wherein the user comprises at least one of an energy provider and a customer with multiple facilities.

21. The device of claim 16, wherein the report includes actual usage, forecast usage and/or cost estimates, responsive to data input by the user; and wherein the preference reflects at least one of: location, demand, time shift, curtailment participation, extrapolation of current usage, adjustment of current usage, billing period and tariff.

22. The device of claim 16, further comprising instructions for, responsive to the at least one preference, providing an estimated forecast of a utility billing statement for the user.

23. The device of claim 16, wherein the report comprises a plurality of sites, and the report includes a summary corresponding to the plurality of sites.

24. The device of claim 16, wherein the report includes at least one line item selected from: delivery charge, service charge, transmission charge, customer charge, distribution charge, computer transmission charge, environmental fund rate, low income fund rate, and power factor adjustment.

25. The device of claim 16, wherein the report has a format resembling a printed billing statement.

26. The device of claim 16, further comprising at least one of components selected from: estimating cost, reporting exceptions, forecasting cost, benchmarking, providing market prices, and analyzing report information; wherein said at least one component utilizes at least one of: the measurement related information, the estimate related information, and the user information.

27. The device of claim 16, further comprising instructions for determining, responsive to a user request, an effect on cost of participation in a curtailment program.

28. The device of claim 27, further comprising instructions for, if the user selected participation in the curtailment program, verifying that the user curtailed.

29. The device of claim 16, wherein at least one of the measurement related information, the estimate related information, and the user information is stored in at least one table.

30. The device of claim 16, wherein the information stored in the at least one table includes at least one of: peak periods, holidays, bill rates, tariff information, factor information for line items, and billing factor criteria.

31. The device of claim 16, further comprising at least one computer, reading the at least one computer readable medium, and displaying the report.

32. The device of claim 16, wherein there are provided a plurality of computers, at least one of said computers transferring, to at least one other of said computers, data representative of at least one of the utility information, the measurement related information and the estimate related information via standard communication protocols.

33. A computer-based system for managing utility information responsive to at least one of usage and estimated usage of utility resources, comprising:
(A) Stored information regarding at least one user, at least one utility relating to the at least one user, and a plurality of rules that may be applied by the at least one utility for the at least one user in determining the utility information;
(B) Stored measurement related or estimate related information representative of the at least one of the utility usage and the estimated usage by the at least one user;
(C) Means for selecting at least one preference representative of a variable utilized in generating the utility information for the at least one user;
(D) Means for generating the utility information for the at least one user responsive to the at least one preference, the utility information relating to the at least one user, the at least one preference, and the measurement related or estimate related information for the at least one user; and
(E) Display means for displaying a report representative of the utility information utilizing the at least one preference.

34. The system of claim 33, wherein the measurement related or estimate related information is acquired remotely from at least one of: a utility meter, a database of meter information, a periodic reading of a utility meter, and a demand reading of a utility meter.

35. The system of claim 33, wherein the utility resource is power characterized by power component information, and wherein the power component information includes real power, apparent power, and reactive power; and wherein the measurement related or estimate related information comprises at least two of the real power, the apparent power and the reactive power; and wherein said means for generating (D) generates the utility information including calculated billing information comprising one another of the at least two of the real power, the apparent and the reactive power.

36. The system of claim 33, wherein the utility resource is power, and the variables include at least one of time period, site, tariff, state tax, city tax, billing cycle, energy usage, location, and curtailment.

37. The system of claim 33, wherein the user comprises at least one of an energy provider and a customer with multiple facilities.

38. The system of claim 33, wherein the report includes actual usage, forecast usage and/or cost estimates, responsive to data input by the user; and wherein the preference reflects at least one of: location, demand, time shift, curtailment participation, extrapolation of current usage, adjustment of current usage, billing period and tariff.

39. The system of claim 33, further comprising an estimated forecast of a utility billing statement, provided to the user responsive to the at least one preference.

40. The system of claim 33, wherein the report comprises a plurality of sites, and the report includes a summary corresponding to the plurality of sites.

41. The system of claim 33, wherein the report includes at least one line item selected from: delivery charge, service charge, transmission charge, customer charge, distribution charge, computer transmission charge, environmental fund rate, low income fund rate, and power factor adjustment.

42. The system of claim 33, wherein the report has a format resembling a printed billing statement.

43. The system of claim 33, further comprising at least one of components selected from: estimating cost, reporting exceptions, forecasting cost, benchmarking, providing market prices, and analyzing report information; wherein said at least one component utilizes at least one of: the measurement related information, the estimate related information, and the user information.

44. The system of claim 33, further comprising information determined, responsive to a user request, reflecting an effect on cost of participation in a curtailment program.

45. The system of claim 44, further comprising a verification, if the user selected participation in the curtailment program, that the user curtailed.

46. The system of claim 33, wherein at least one of the measurement related information, the estimate related information, and the user information is stored in at least one table.

47. The system of claim 33, wherein the information stored in the at least one table includes at least one of: peak periods, holidays, bill rates, tariff information, factor information for line items, and billing factor criteria.
